(19) United States
(12) Patent Application Publication
(10) Pub. No.: US 2024/0246751 A1
(43) Pub. Date: Jul. 25, 2024

(54) MEMBRANE ATTACHED TO A CARTRIDGE BY SEALS WITH DIFFERING STRENGTHS

(71) Applicant: Cana Technology, Inc., Redwood City, CA (US)

(72) Inventor: Aaron Wehls, San Carlos, CA (US)

(21) Appl. No.: 18/122,112

(22) Filed: Mar. 15, 2023

Related U.S. Application Data
(60) Provisional application No. 63/440,904, filed on Jan. 24, 2023.

(51) Int. Cl. B65D 85/804; A47J 31/40

(52) U.S. Cl. CPC B65D 85/8064; A47J 31/407; B65D 85/8049

(57) ABSTRACT

Methods and systems related to membrane attached to a cartridge of a fluid dispensing device are disclosed. A disclosed cartridge includes a membrane that is attached to the cartridge by a first seal and a second seal, wherein the first seal is stronger than the second seal, before the cartridge is installed into the dispensing device. The second seal is broken during the installation of the cartridge into the dispensing device by applying a pressure from a pneumatic system external to the cartridge, but the first seal remains intact at the applied pressure. A method for installing the cartridge into the dispensing device and breaking the second seal as part of the installation of the cartridge into the device is disclosed.

### CROSS REFERENCE TO RELATED APPLICATIONS

This application claims the benefit of U.S. Provisional Pat. App. No. 63/440,904 filed Jan. 24, 2023, which is incorporated by reference herein in its entirety for all purposes.

### BACKGROUND

Fluid dispensing devices can contain fluids of differing kinds. The fluids can be kept separate from one another, and on demand, dispensed from the devices. Such fluids may be kept in a cartridge that can be inserted into a dispensing device and removed when refilling becomes necessary. Refilling can be done at a location, such as factory, away from the premises where the dispensing device is used and operated, such as at restaurants, hospitals, etc. Whether the cartridges are new or have been refilled at a factory, the cartridges are shipped to the users of the fluid dispensing device.

Such cartridges often use one or more membranes made of polymer materials for various operational purposes of the fluid dispensing devices. Membranes are a cost-effective component choice that offer numerous benefits to achieve operational purposes. Certain fluidic structures of the cartridge, though covered by the membrane, must remain open during the operation of the fluid dispensing device for its proper functioning. This presents a problem during the shipment of the cartridge: fluids contained in the cartridge may leak through the open fluidic structures and/or cross-contaminate in that one fluid mixes with another fluid contained in the cartridge.

### SUMMARY

Methods and systems related to cartridges for fluid dispensing devices are disclosed. The systems disclosed herein include a cartridge to which a membrane is attached by seals of differing strengths such as a first seal that is stronger than a second seal. During the shipment of the cartridge, the second seal can prevent leakage and/or cross-contamination mentioned above. During the installation of the cartridge into the fluid dispensing device, the second seal can be broken (e.g., by applying a pressure to the cartridge), and the first seal, which is stronger than the second seal, remains intact. The first seal is of such strength that it remains intact throughout the operation of the device and thereby, keeps the membrane attached to the cartridge for various operational purposes of the fluid dispensing device.

In specific embodiments of the invention, a cartridge, shaped for installation into a fluid dispensing device, is provided. The cartridge comprises at least one ingredient reservoir containing a liquid ingredient, the at least one ingredient reservoir having an orifice; and a membrane attached to the cartridge by a first seal and a second seal, wherein the first seal is stronger than the second seal; wherein the second seal is broken as part of the installation of the cartridge into the fluid dispensing device; wherein the first seal remains intact throughout the installation of the cartridge into the fluid dispensing device and during operation of the fluid dispensing device; and wherein the liquid ingredient is dispensed from the at least one ingredient reservoir through the orifice during the operation of the fluid dispensing device. In specific embodiments of the invention: the cartridge comprises an inlet connected to a pressure source external to the cartridge; during the installation of the cartridge into the fluid dispensing device, a pressure is supplied, through the inlet, to the cartridge, and the second seal breaks when the pressure is at a target pressure; and the first seal remains intact at the target pressure. For the avoidance of doubt, the phrase “as part of the installation of the cartridge into the fluid dispensing device” includes the mechanical action of the cartridge being inserted into or otherwise connected to the device, and also includes further actions that prepare the cartridge for use such as electronically or mechanically actuated actions that prepare the cartridge for use (e.g., the action of a controller administrating the pressurization of the cartridge or at least one ingredient reservoir of the cartridge) even when those further actions take place at disparate times from the initial connection of the cartridge to the device.

In specific embodiments of the invention, a fluid dispensing device is provided. The fluid dispensing device comprises a cartridge shaped for installation into a fluid dispensing device. The cartridge comprises: at least one ingredient reservoir containing a liquid ingredient, the at least one ingredient reservoir having an orifice; an inlet; and a membrane attached to the cartridge by a first seal and a second seal, wherein the first seal is stronger than the second seal. The fluid dispensing device also comprises: a pneumatic system; and a controller storing instructions that, when executed, cause the fluid dispensing device to supply, using the pneumatic system, one or more valves, and the inlet, pressurized air to the cartridge; wherein a pressure from the pressurized air breaks the second seal as part of the installation of the cartridge into the fluid dispensing device; wherein the first seal remains intact throughout the installation of the cartridge into the fluid dispensing device and during operation of the fluid dispensing device; and wherein the liquid ingredient is dispensed from the at least one ingredient reservoir through the orifice during the operation of the fluid dispensing device.

In specific embodiments of the invention, a method for installing a cartridge into a fluid dispensing device is provided, wherein the cartridge is shaped for installation into the fluid dispensing device and has a membrane attached to the cartridge by a first seal and a second seal. The method comprises the steps of inserting the cartridge into the fluid dispensing device; and supplying, from a pressure source of the fluid dispensing device, pressurized air to the cartridge through an inlet of the cartridge. The first seal is stronger than the second seal. The second seal breaks at a pressure from the pressurized air. The first seal remains intact at the pressure.

### BRIEF DESCRIPTION OF THE DRAWINGS

FIG. 1A illustrates an example of a fluid dispensing device, in accordance with specific embodiments disclosed herein.

FIG. 1B illustrates exemplary internal components of a fluid dispensing device, such as the fluid dispensing device in FIG. 1A, in accordance with specific embodiments disclosed herein.

FIG. 2 illustrates an example of a cartridge, with a membrane removed, in accordance with specific embodiments disclosed herein.

FIG. 3 illustrates an example view of the bottom side of the cartridge in FIG. 2, with a membrane removed, in accordance with specific embodiments disclosed herein.

FIG. 4 illustrates a schematic cross-sectional view of a membrane, in accordance with specific embodiments disclosed herein.

FIG. 5 illustrates examples of surface areas for forming seals on a top side of a cartridge with two ingredient reservoirs and attaching a membrane to the top side, in accordance with specific embodiments disclosed herein.

FIG. 6 illustrates examples of surface areas for forming seals on a bottom side of a cartridge with two ingredient reservoirs and attaching a membrane to the bottom side, in accordance with specific embodiments disclosed herein.

FIG. 7 illustrates example cross-sectional views of a base of the cartridge in FIG. 6.

FIG. 8A illustrates a membrane attached, by a plurality of first seals and a plurality of second seals, to the top side of a cartridge in FIG. 2, in accordance with specific embodiments disclosed herein.

FIG. 8B illustrates an exploded view of membrane and seals in FIG. 8A.

FIG. 9A illustrates a cartridge with more than two ingredient reservoirs, with a membrane attached, by seals, to a bottom side of the cartridge, in accordance with specific embodiments disclosed herein.

FIG. 9B illustrates an exploded view of membrane and seals in FIG. 9A.

FIG. 10 illustrates a block diagram including exemplary components of a fluid dispensing device, with a cartridge installed, in accordance with specific embodiments disclosed herein.

FIG. 11 illustrates flowcharts for methods for installing a cartridge in a fluid dispensing device after the cartridge has been inserted into the device, in accordance with specific embodiments disclosed herein.

FIG. 12 illustrates example cross-sectional views of a dispensing valve, an orifice, a membrane, and seals during the installation of a cartridge into the device, in accordance with specific embodiments disclosed herein.

FIG. 13 illustrates a sectional view of the interior of a cartridge including a pressurizable chamber after the installation of the cartridge into the device, in accordance with specific embodiments disclosed herein.

FIG. 14 illustrate a fluid dispensing device with an installed cartridge comprising self-enclosed ingredient reservoirs, in accordance with specific embodiments disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

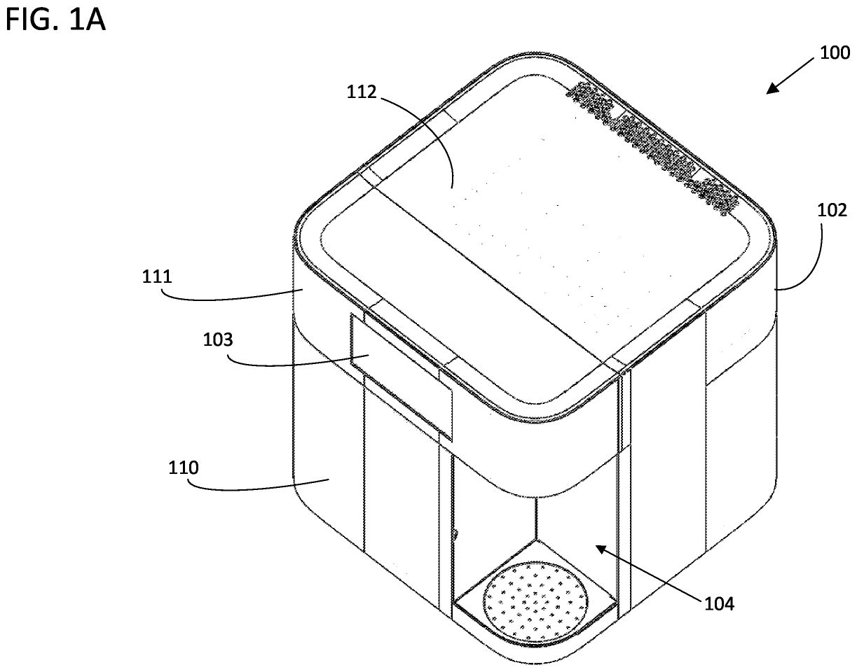

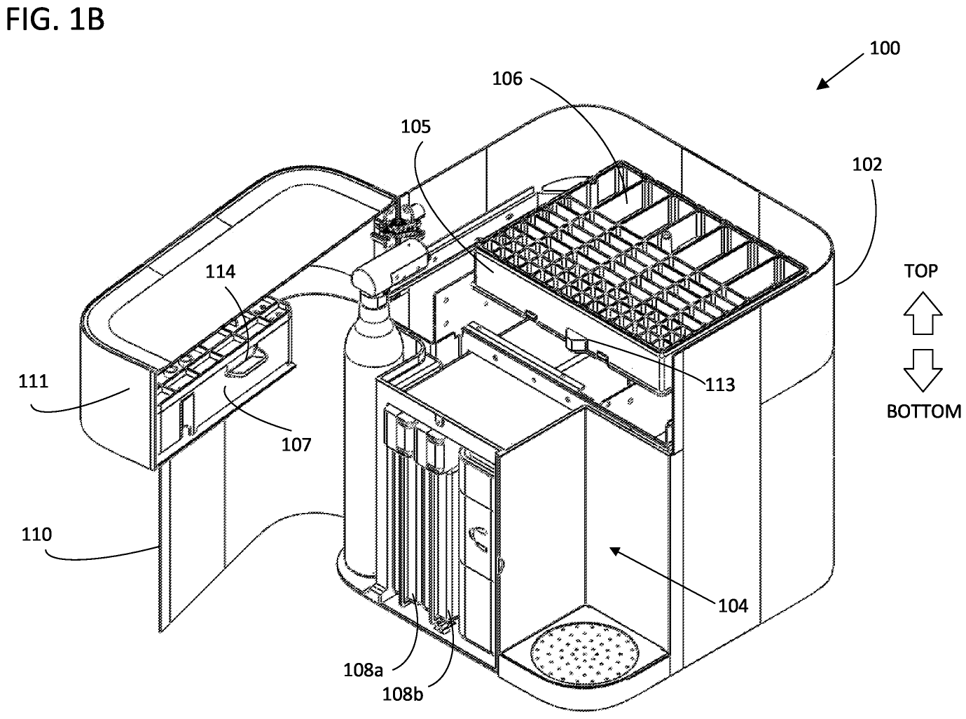

Different components and methods for a fluid dispensing system in form of a device, such as fluid dispensing device 100 illustrated in FIGS. 1A and 1B, will be described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

A fluid dispensing device can contain and store multiple different fluids, or liquid ingredients, which are kept separated from one another, and one or more of such fluids can be dispensed on demand by a user of the device. The liquid ingredients contained in such a fluid dispensing device vary by type, chemical formulation, and/or composition depending upon the application of the device. For example, in a medical clinic, the fluid dispensing device may contain liquid form drugs or chemicals used for surgeries, which may be dispensed as needed. In the sanitation industry, a fluid dispensing device may contain various liquid cleaning agents, which are then dispensed as needed. A fluid dispensing device can also be a beverage dispensing device used at home, a restaurant, a convenience store, or another public venue; such a device can contain multiple liquid ingredients from which a wide variety of beverages can be made.

FIG. 1A illustrates an example of a fluid dispensing device 100 in accordance with specific embodiments disclosed herein. The fluid dispensing device can be any of the fluid mixture dispensing devices described in U.S. patent application Ser. No. 17/548,318 filed on Dec. 10, 2021, U.S. patent application Ser. No. 17/549,670 filed on Dec. 13, 2021, and U.S. patent application Ser. No. 17/547,081 filed Dec. 9, 2021, all of which are incorporated by reference herein in their entirety for all purposes.

The fluid dispensing device 100 can include a casing, such as casing 102, that can house various internal components of the device. The casing 102 can include various accesses to the interior of the device. The accesses can be in the form of doors, such as lower access door 110, upper access door 111, and top lid 112. The accesses can be configured so that a user of the device can access at least part of the interior of the device, for example, to replace a component, such as a cartridge, as will be described below in more detail.

The fluid dispensing device 100 can also include a user interface (UI), such as user interface 103, to facilitate the interaction of a user of the device with the device. The user interface 103 can include any means for inputting information from the user of the device to the device and for outputting information from the device to the user. The components facilitating the user interface can be associated to a controller of the device so that the controller can administrate and process the information being received and the information to be outputted. The fluid dispensing device 100 can also include a dispense area, such as dispense area 104, which can be the area where a fluid mixture beverage is dispensed out of the device 100. Dispense area 104 can be an area configured to receive a vessel or other containers, such as a plastic glass, a cocktail glass, or a wine glass, to dispense a fluid mixture beverage out of device 100.

FIG. 1B illustrates a fluid dispensing device, such as device 100 in FIG. 1A, in an open configuration to illustrate various exemplary internal components that can be housed by the casing 102, in accordance with some embodiments disclosed herein. In the example of FIG. 1B, a top lid and a membrane at the top of the device 100 have been removed to expose some additional exemplary components of the device.

Throughout this disclosure, occasionally, references will be made to “top” and “bottom” sides of the cartridge or the fluid dispensing device will be made. These references are in accordance with the directions of the arrows shown in FIG. 1B. Further, in various figures herein, the dimensions of seals have been magnified in order to more clearly describe the concepts disclosed herein.

The fluid dispensing device 100 can include one or more cartridges, such as cartridge 105. A cartridge, in accordance with specific embodiments of the invention, can comprise a plurality of ingredient reservoirs, such as ingredient reservoir 106. However, a cartridge can comprise only two ingredient reservoirs, and it can comprise only one ingredient reservoir. The ingredient reservoirs 106 can store liquid ingredients to be used or dispensed by the fluid dispensing device 100. As mentioned, the cartridge can be accessed via one of the accesses of the device, such as lower access door 110, upper access door 111, and top lid 112. In this way, a user of the device can replace the cartridge as needed, such as when the ingredient reservoirs run low or are empty of liquid ingredients.

The ingredient reservoirs 106 can store ingredients to be used by the fluid dispensing 100, to create a fluid mixture or beverage. An ingredient reservoir can include an “ingredient” also referred to herein as an “ingredient mixture.” An ingredient mixture can include at least one primary/functional ingredient. A primary/functional ingredient can be at least one of a solid, liquid, or a gas. An example of a primary/functional ingredient can be chemical compounds. In some embodiments, the ingredient mixture can include various concentrations of chemical compounds. In some embodiments, an ingredient mixture can include at least one solvent. The at least one solvent can be any combination of solvents disclosed herein. For example, an ingredient mixture in an ingredient reservoir can be a mixture of citric acid (primary/functional ingredient) and water at a particular concentration. Another ingredient mixture can be a mixture of potassium sulfate (primary/functional ingredient), water, and ethanol.

A fluid dispensing device of specific embodiments of the invention can include one or more solvent reservoirs, such as solvent reservoirs 108a and 108b. The solvent reservoirs can store solvents to be used by the fluid mixture dispensing device 100 to create a fluid mixture, such as water, alcohol, etc. The solvent reservoirs can be any of the solvent reservoirs described in U.S. patent application Ser. No. 17/551,581 filed on Dec. 15, 2021, and U.S. patent application Ser. No. 17/547,081 filed Dec. 9, 2021, all of which are incorporated by reference herein in their entirety for all purposes. The fluid dispensing device in some embodiments can include a mixing chamber or final dispense reservoir, such as mixing chamber 107. Mixing chamber 107 can be connected to the fluid outlet 113 of the cartridge via the fluid inlet 114. The final dispense reservoir or mixing chamber can be any of final dispense reservoirs described in U.S. patent application Ser. No. 17/548,318 filed on Dec. 10, 2021.

In some embodiments of the fluid dispensing device, when a user requests a beverage or another final mixed product, the device, based upon a recipe for the requested beverage or product stored in a memory of the device, a controller of the device, or a network accessible database available to the device, dispenses one or more liquid ingredients from the cartridge to a mixing chamber, mixes, in the mixing chamber, the one or more dispensed liquid ingredients with one or more solvents to prepare the beverage or mixed product, and dispenses the beverage or product is out of fluid the device and into a vessel. In other embodiments of the fluid dispensing device, liquid ingredients dispensed from one or more ingredient reservoirs are not mixed with one another or with a solvent in an internal compartment, such as a mixing area or mixing chamber, but are dispensed directly out of the dispensing device through one or more output nozzles and into one or more vessels.

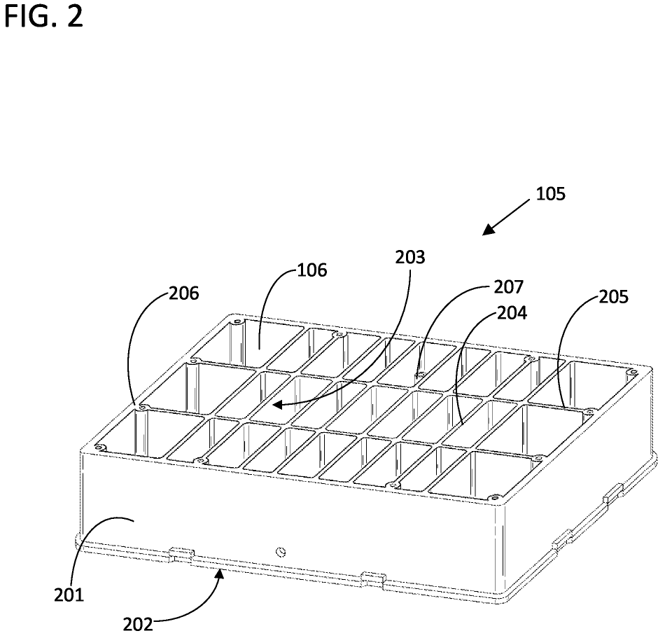

FIG. 2 illustrates an example of a cartridge 105, in accordance with specific embodiments disclosed herein. In the illustrated view 200, a membrane at the top side of the cartridge has been removed. As illustrated, the cartridge has twenty-seven ingredient reservoirs, such as ingredient reservoir 106. The cartridge has four peripheral walls 201 on four lateral sides of the cartridge and a base 202 at the bottom side of the cartridge. The inside area of the cartridge, surrounded by the peripheral walls, is partitioned, by a number of internal walls, such as internal wall 203, into multiple ingredient reservoirs 106. Each ingredient reservoir thus has four walls, such as wall 203, and the cartridge's peripheral walls form one or more walls of some of the ingredient reservoirs located on the perimeter of cartridge. The top of these walls provides surface areas 204, 205, 206, to which a membrane (not shown in FIG. 2) can be attached. The cartridge's base forms a base of each of the ingredient reservoirs—that is, a portion of the cartridge's base forms the base of each reservoir. FIG. 2 also illustrates an example of a gas inlet 207, depicted as a cylindrical pipe/tube rising from the base of the cartridge. In the illustrated view 200, the gas inlet is housed in one of the ingredient reservoirs, abuts an internal wall of the one ingredient reservoir, and has a top circular surface area that is at the same horizontal plane as the top of the internal wall of the one ingredient reservoir. However, the gas inlet can be of any shape (e.g., a rectangular pipe/tube), and it can be housed within a wall itself.

The cartridge's base 202 can include various interfacing components for interfacing the cartridge with corresponding interfacing components of a fluid dispensing device, such as fluid dispensing device 100, during the installation of the cartridge into the device. For example, base 202 can include respective orifices of the ingredient reservoirs 106; one or more channels for facilitating fluidic paths between the orifices and other parts of the device; and one or more inlets for (a) flowing solvents from solvent reservoirs, such as solvent reservoirs 108a, 108b, through the channels; (b) supplying pressurized air, from a pneumatic system of the fluid dispensing device, to the channels to move solvents flowed from one or more solvent reservoirs or ingredients dispensed through the orifices of one or more ingredient reservoirs; and/or (c) supplying pressurized air, from a pneumatic system of the fluid dispensing device, to an area, i.e., a pressurizable chamber, at the top side of the cartridge between the ingredient reservoirs and a membrane, etc. Such interfacing components can be formed into or inside the base during the manufacturing of the cartridge. In some embodiments, multiple channels may be formed inside the base of the cartridge, running horizontally in parallel to the bottom surface of the cartridge; such channels may connect the ingredient reservoirs to their respective orifices formed on the cartridge's peripheral walls near the base of the cartridge. In some embodiments, the base of the cartridge is thicker than the walls of the cartridge and the ingredient reservoirs; a thicker base can house multiple interfacing components and make the cartridge more stable when the cartridge is installed into the fluid dispensing device. In some embodiments, the base of the cartridge may not include a channel.

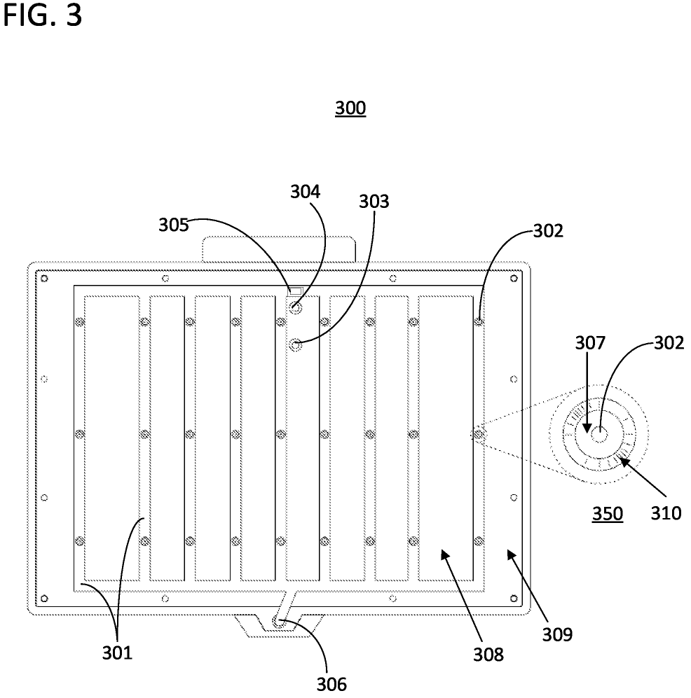

FIG. 3 illustrates an example view 300 of the bottom side of a cartridge in accordance with specific embodiments disclosed herein. In the figure, a membrane that attaches to the bottom side of the cartridge has been removed to illustrate various features of the bottom side of the cartridge. FIG. 3, includes one or more channels 301 (e.g., two channels, illustrated as horizontal in FIG. 3, and nine channels, illustrated as vertical), multiple orifices 302, one respectively for each ingredient reservoir 106 of the cartridge (e.g., in FIG. 3, twenty-seven orifices), gas inlet 303 through which pressurized gas or air is supplied to the top side of the cartridge within a space between the top side of the ingredient reservoirs and a membrane, fluid inlet 304 through which solvents are supplied to the channels from solvent reservoirs 108a, 108b and pressurized gas or air is supplied to the channels from a pneumatic system of the fluid dispensing device, a connection point 305 enabling fluid or pressurized gas/air from the fluid inlet 304 to enter the one or more channels, and a fluid outlet 306, such as fluid outlet 113 in FIG. 1B, which fluidly connects the channels to fluid inlet 114 of mixing chamber 107. Whereas gas inlet 207 is the opening of a tube/pipe at the top side of the cartridge as shown in FIG. 2, gas inlet 303 as shown in FIG. 3 is the other opening of the tube/pipe at the bottom side of the cartridge.

As illustrated in FIG. 3, the respective orifices of the ingredient reservoirs, in accordance with specific embodiments of the cartridge, are disposed within the channels. An enlarged view of an orifice 350 is illustrated in FIG. 3. This enlarged view shows orifice 302, a surface area 307 that completely surrounds the orifice and forms a mesa, and a surface area 310 being on a protruding part of the bottom side of the cartridge located within a channel (in FIG. 3, there are twenty-seven mesas, each surrounding one orifice). References 308 and 309 illustrate multiple other surface areas: in FIG. 3, there are eight vertical surface areas, such as one referenced as 308, between a pair of neighboring vertical channels, and a surface area along the perimeter of the bottom side of the cartridge, such as one referenced as 309, that at least partially surrounds all channels, vertical and horizontal. To these surface areas, 307, 308, 309, of the base of the cartridge, a membrane (not shown in FIG. 3) can be attached.

In some embodiments, at least one of the orifices may include a sealing valve, such as a piercing valve, which prevents leakage through the orifice during the shipping of the cartridge; such an orifice can be disposed on surface areas, such as surface areas 308, 309 in FIG. 3, but not within a channel. When the cartridge of such embodiments is installed into a fluid dispensing device, a corresponding pipe of the device can pierce into the valve to establish a fluidic path from the at least one of the orifices to a pump inside the device, and the pump can, in turn, dispense, through the sealing valve, a liquid ingredient from the cartridge and into, for example, a mixing chamber. In some embodiments, all the orifices may include sealing valves such as just described.

In various embodiments of the invention, the cartridge is refillable and reusable. When ingredient reservoirs 106 run low on liquid ingredients, the user of the dispensing device can remove the cartridge from the fluid dispensing device and insert and install another cartridge filled with liquid ingredients. Empty and used cartridges can be refilled at a factory location which may be away from the user's premises, such as homes, restaurants, convenience stores, etc. At the factory, used cartridges can be refurbished, and such refurbishments may include replacing membranes attached to the cartridge. Once refurbished and refilled with ingredients, the cartridges can be shipped to one or more users of the same make and model fluid dispensing device. Therefore, it is desirable to manufacture cartridges that are durable.

In various embodiments of the invention, the cartridge is made of rigid materials. In this way, the cartridge is rigid and therefore, durable. “Rigid” as used herein means that the walls and base of the cartridge and of its ingredient reservoirs do not deform substantially or change their shapes due to the weight or volume of the liquid ingredients contained therein, or deform substantially from pressures applied externally to the cartridge. Using injection molding processes known in the art, a rigid cartridge can be made from a wide variety of materials. Such materials include: polyethylene of all molecular weights, such as low-density polyethylene (LDPE), medium-density polyethylene (MDPE), high-density polyethylene (HDPE), and ultra-high molecular weight polyethylene (UHMW); polypropylene (PP); PP copolymers; polyethylene terephthalate (PET); Poly(methyl methacrylate) (PMMA); cyclo olefin polymer (COP); cyclic olefin copolymer (COC); metal; glass or other ceramics; multi-scale composite materials, etc. The choice of a particular material to be used in the injection molding process to manufacture a cartridge can depend on several factors, including manufacturing cost, the extent of durability, and compatibility with the type of membranes used in the cartridge. Once a particular material is chosen, injection molding processes can be used to mold the material into a cartridge of a desired shape and construction such that the cartridge is shaped for installation into a particular fluid dispensing device. In this way, when the cartridge is installed into a particular fluid dispensing device, the cartridge and the device fit together, and various interfacing components of the cartridge (such as channels 301, orifices 302, gas inlet 303, fluid inlet 304, fluid outlet 306, etc.) mate with their corresponding interfacing components of the fluid dispensing device.

Various embodiments of the cartridge include at least one membrane to facilitate various functions of a corresponding fluid dispensing device. Some embodiments of the cartridge include a membrane at the top side of the cartridge, but not at the bottom side of the cartridge. Some embodiments of the cartridge include a membrane at the bottom side of the cartridge, but not at the top side of the cartridge. Other embodiments of the cartridge include a membrane at the top side of the cartridge as well as a membrane at the bottom side of the cartridge.

In specific embodiments of the cartridge, a membrane is disposed at the bottom side of the cartridge and is attached to the base of the cartridge. In such embodiments, the membrane covers the orifices disposed within the channels, and the membrane and channels together form a fluidic path from the orifice along the bottom side of the cartridge. In such embodiments, during the operation of the fluid dispensing device, the membrane of the cartridge, in combination with dispensing valves of the fluid dispensing device, is used to selectively open and close respective orifices of one or more ingredient reservoirs so that liquid ingredients can be dispensed, in predetermined amounts, into one or more fluidic paths, such as channels, from the reservoirs. In such embodiments, there is one dispensing valve for each orifice, and the valves are disposed in the dispensing device. The dispensing valves can be any of the valves disclosed in U.S. patent application Ser. No. 17/547,081 filed on Dec. 9, 2021, which is incorporated by reference herein in its entirety for all purposes.

In some embodiments of the cartridge, a membrane is disposed above the ingredient reservoirs at the top side of the cartridge, and the membrane is attached to the top side of the cartridge. In such embodiments, after the installation of the cartridge into the fluid dispensing device, the membrane forms a pressurizable chamber above the ingredient reservoirs: the pressurizable chamber's sides are defined by a side of the membrane facing the ingredient reservoirs, the walls of the cartridge, and the surfaces of the liquid ingredients stored in the ingredient reservoirs. During the operation of the fluid dispensing device, the pressurizable chamber is pressurized by supplying pressurized gas or air through an inlet, such as inlets 207, 303, from a pneumatic system of the device. A pressure within the chamber, i.e., an operational pressure, facilitates dispensing of the liquid ingredients through the ingredient reservoirs' respective orifices.

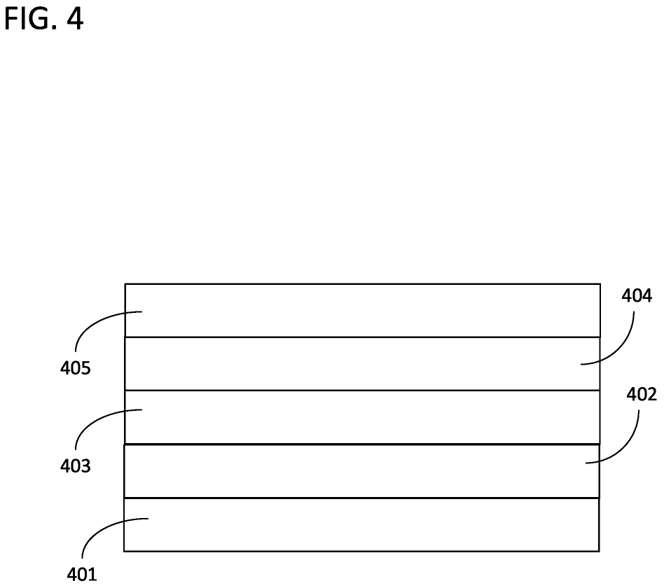

In specific embodiments of the invention, the membrane is a flexible membrane. The membrane must have adequate tensile and tear strength such that it does not fail at an operational pressure (the term “operational pressure” is defined below). In some embodiments, the membrane is made of thermoplastic materials. In some embodiments, the membrane can comprise multiple layers of films. In specific embodiments of the invention, as illustrated in FIG. 4, the membrane comprises at least five layers of films: a sealant layer 401, tie layer 402, barrier layer 403, tie layer 404, and exterior layer 405. The sealant layer 401 allows the membrane to be heat-sealed to surface areas of a structure or component part, such as a cartridge, and can provide a moisture barrier. The sealant layer can be made of linear low-density polyethylene (LLDPE), LDPE, PP, PET etc. films. The barrier layer 403 can provide a barrier to the transmission of certain materials such as oxygen, water vapor, and low molecular weight components; it can be made of metalized polyethylene terephthalate (metPET), polyvinylidene dichloride (PvdC), aluminum foil, aluminum oxide, silicon oxide, etc. films. The exterior layer 405 protects the membrane from tearing and puncturing protection; it can be made of PE, PET, etc. The tie layers 402, 404 can be adhesive layers such as urethane adhesives, and each tie layer bonds adjacent two layers on its sides. Each layer's thickness can be on the order of micrometers. In some embodiments, the membrane can have fewer than five layers. The membrane can be made by extrusion, coextrusion, or other processes known in the art. In some embodiments, the multiple layered films described above can be formed of a co-extruded film of two or more layers, in which case the tie layers may not be necessary. Furthermore, in applications in which a barrier is not required, the membrane could comprise a single layer of material. In some embodiments, the tie layers can be applied as a liquid to the other layers of a film to which they are a part.

Because the sealant layer provides sealing of the membrane to the surface areas of the cartridge, the choice of sealant layer material depends on the type of the material of which the cartridge is made. For example, PP and PET sealant layers do not bond well with surface areas made of PET or PMMA. In specific embodiments of the invention, the cartridge is rigid and made of injection molded HDPE as discussed above, and the sealant layer of the membrane is made of LLDPE film. In such specific embodiments, the cartridge's surface areas to which a membrane can be attached are rigid; hence, the surface areas are rigid surface areas.

In various embodiments of the invention, a membrane is attached to the cartridge by a first seal and a second seal. The strength of the seals is different in that the first seal is stronger than the second seal. The strength of a seal is defined by an amount of pressure applied to the membrane at which a seal breaks. The second seal can break at a target pressure when such target pressure is applied to the membrane, for example, within a pressurizable chamber formed by the membrane at the top of the cartridge or inside the fluid path formed by the membrane and a channel at the bottom of the cartridge. The first seal is stronger than the second seal in that it remains intact at the applied target pressure that breaks the second seal. In some embodiments, the target pressure is greater than a vapor pressure formed within one or more ingredient reservoirs; such vapor pressure may be formed due to ambient heat outside the cartridge, for example, during the shipment of the cartridge to a user or otherwise prior to the installation of the cartridge into the fluid dispensing device.

According to various embodiments of the invention, cartridges can be of various shapes and sizes, can be shaped for a variety of dispensing mechanisms of fluid dispensing devices, and can include any number of ingredient reservoirs. In some embodiments, a cartridge can comprise only one ingredient reservoir. In some embodiments, a cartridge can comprise only two ingredient reservoirs. In some embodiments, a cartridge can comprise 100 ingredient reservoirs. According to various embodiments of the invention, ingredient reservoirs can be of various shapes and sizes, and can have various structural features. In some embodiments, one or more ingredient reservoirs can have a side open at the top side of the cartridge. In some embodiments, one or more ingredient reservoirs can have a closed side at the top side of the cartridge, such as when the one or more reservoirs are made of bladder bags or syringes. In some embodiments, one or more ingredient reservoirs of a cartridge can have orifices that are fitted with respective sealing valves, such as piercing valve, and in such embodiments, the fluid dispensing device's dispensing mechanism comprises corresponding pipes that can, during the installation of the cartridge into the device, pierce into the valves of the one or more ingredient reservoirs to establish fluidic paths from the one or more ingredient reservoirs to respective one or more pumps or other components inside the device. In some embodiments, all of the ingredient reservoirs of a cartridge can have orifices that are fitted with respective sealing valves, such as piercing valve. In some embodiments, the orifices of one or more ingredient reservoirs of the cartridge are located at the bottom of side of the base of a cartridge. In yet other embodiments, the orifices of one or more ingredient reservoirs of the cartridge are located within one or more channels formed at the bottom of side of the base of a cartridge, and in such embodiments, as discussed above, the dispensing mechanism of the fluid dispensing device comprises dispensing valves for dispensing liquid ingredients from the ingredient reservoirs into the one or more channels. In some embodiments, orifices of one or more ingredient reservoirs of the cartridge are located on a peripheral wall of a cartridge. In some embodiments, orifices of one or more ingredient reservoirs of the cartridge are located on the cartridge's peripheral walls proximate the base of the cartridge.

In some embodiments, the ingredient reservoirs contain ingredients, such as a solid (including crystalline, powdered, or other forms of a solid), a liquid, or a gas. In some embodiments, the ingredient reservoirs contain ingredients formed by solid solutes dissolved in various types of liquid solutions. In some embodiments, the ingredient reservoirs contain ingredients formed by gases dissolved in various types of liquid solutions, for example, carbon dioxide dissolved in water. Examples of liquid ingredients include flavorings, syrups, and chemicals such as citric acid (in a solution). In some embodiments, liquid ingredients comprise, as a constituent part, at least one selected from the group consisting of glycerine (glycerol), fructose, glucose, lactic acid, malic acid, tartaric acid, potassium phosphate tribasic, sucrose, succinic acid, acetic acid, citric acid, tricalcium phosphate, magnesium hydroxide, 3-methylbutan-1-ol, sodium phosphate dibasic, propanol, starter distillate 9×, ethyl acetate, 2-methylbutan-1-ol, 2-methylpropan-1-ol, 2-phenylethanol, oxolan-2-one, iron sulfate heptahydrate, octanoic acid, hexanoic acid, 3-methylbutyl acetate, decanoic acid, hexan-1-ol, ethyl octanoate, furan-2-ylmethanol, ethyl hexanoate, 2-methylpropanoic acid, furan-2-carbaldehyde, ethyl butanoate, 2,6-dimethoxyphenol, ethyl decanoate, hexyl acetate, 2-phenyl ethyl acetate, 3-methylsulfanylpropan-1-ol, ethyl propionate, butan-1-ol, 4-hydroxy-3-methoxybenzaldehyde, 5-methylfuran-2-carbaldehyde, isobutyl acetate, 5-pentyloxolan-2-one, ethyl 2-methylpropanoate, 5-butyl-4-methyloxolan-2-one, 2-methoxy-4-methylphenol, 2-methoxy-4-prop-2-enylphenol, and/or 2-methoxyphenol.

According to various embodiments of the invention, a membrane is used and attached to a cartridge for one or more of various purposes, including separating liquid ingredients from each other, covering a dispensing orifice, covering an orifice for adding a solvent to the cartridge, covering a gas outlet such as an air vent, covering a gas inlet, forming, during the operation of the fluid dispensing device, a pressurizable chamber to apply pressure to the ingredients contained within the ingredient reservoirs in order to facilitate dispensing of ingredients, and forming, during the operation of the fluid dispensing device, a fluidic path between dispensing orifices and other components of the dispensing device, etc. In some embodiments, a cartridge can have only one membrane attached to the cartridge, and in some embodiments, a cartridge can have a plurality of membranes attached to the cartridge. As discussed above, at a factory setting, away from the premises where the fluid dispensing device is kept and operated, a membrane can be attached to the rigid surfaces of the cartridge by one or more first seals and by one or more second seals. The second seals are used to prevent, during the shipment of the cartridge from the factory to the premises and before the cartridge is installed into the fluid dispensing device, leakage, unwanted dispensing, or cross-contamination, etc. of ingredients contained in the ingredient reservoirs. During the installation of the cartridge, the second seals are broken. The first seals remain intact during the installation of the cartridge into the fluid dispensing device and throughout the operation of the fluid dispensing device. In this way, the first seals are used to keep the membrane attached to the cartridge so that, for example, a pressurizable chamber or a fluidic path, as discussed above, are formed for operation of the dispensing device.

In some embodiments of the invention, the target pressure, at which a second seal breaks, is less than an operational pressure of the fluid dispensing device, and the first seal remains intact at the target pressure as well as at the operational pressure. In some embodiments of the invention, the target pressure, at which a second seal breaks, is equal to an operational pressure of the fluid dispensing device, and the first seal remains intact at the target pressure that is also the operational pressure. The operational pressure can be a pressure formed during the installation of the cartridge into a fluid dispensing device, upon the installation of the cartridge into the fluid dispensing device, or after the installation of the cartridge into the fluid dispensing device. For example, the operational pressure can be a pressure formed in the cartridge to facilitate dispensing of an ingredient from the cartridge. In some embodiments, a pressurizable chamber at the top of the cartridge is pressurized, by using pressurized air or gas supplied by a pneumatic system of the dispensing device, at the operational pressure to facilitate dispensing, during the operation of the fluid dispensing device, of liquid ingredients from the ingredient reservoirs and through their respective orifices; and such pressure is also applied to the membrane that forms a one side of (e.g., a ceiling of) the pressurizable chamber. Another example of the operational pressure can be the pressure that is applied to a membrane at a bottom side of a cartridge during the operation of the device, when such a pressure is supplied, by using pressurized air or gas from a pneumatic system of the dispensing device, to the channels to move solvent flowed into the channels and/or liquid ingredients, dispensed from the ingredient reservoirs through their respective orifices and into the channels, from the channel to other components, such as a mixing chamber, of the dispensing device. Yet another example of the operational pressure can be the pressure that is applied to a membrane at the bottom side of a cartridge during the operation of the device, when such a pressure is supplied, by using pressurized air or gas from a pneumatic system of the dispensing device, to the channels to clean or flush the channel.

In some embodiments, the target pressure at which the second seal breaks is between 0.1 psi and 10 psi. In some embodiments, the operational pressure is between 10 psi and 100 psi. The device can also have multiple operational pressures for different purposes, multiple target pressures, and different sets of first and second seals as described above. For example, one set of first seals could be designed to withstand a higher operational pressure than another set of first seals. As another example, one set of weaker second seals could be designed to break at a lower target pressure than a target pressure used to break another set of second seals. The different sets of second seals, that are designed to break at different operational pressures, could isolate specific subsets of ingredients in an ingredients cartridge that are meant to be kept fresh or isolated until their time of use. As mentioned above, the subsets of seals that are broken at a later time would still be considered to be broken during installation as installation includes everything from connecting a cartridge to a device to the point at which the ingredients may actually be dispensed from the device for the first time.

A plurality of first seals that include the first seal and a plurality of second seals that include the second seal can be formed between one or more membranes and rigid surface areas of the cartridge by using hot plate heat-sealing machines, impulse heat-sealing machines, laser sealing machines, and other equipment known in the art. For example, in a heat-sealing process, the membrane is pressed against the rigid surface areas of the cartridge such that the membrane's sealant layer is in direct contact with the cartridge's rigid surface areas, and heat is applied from a side of the membrane where the exterior layer is and that is opposite to the side of the membrane where the sealant layer is to melt the sealant layer to a molten or partially molten stage, and thereby, to form the seals. Whereas the sealant layer melts, the other layers of the membrane do not melt because their melting points are much higher than that of the sealant layer. The strength of a seal depends on three heat-sealing process variables: temperature, dwell time, and pressure. In specific embodiments, whereas the first seals are formed at a first set temperature, dwell time, and pressure, the second seals are formed at a second set of temperature, dwell time, and pressure. Typically, two of the three variables can be smaller in magnitude to form the second seals: for example, at a given pressure, the temperature used to form the second seals can be lower than the temperature used to form the first seals and the dwell time used to form the second seals can be shorter than the dwell time used to form the first seals.

In a heat-sealing a process, one hot plate of the sealing machine that applies heat to the membrane can be patterned to match the layout (i.e., map) of the rigid surface areas of the cartridge where the second seals are to be formed, and another hot plate can be patterned to match the layout of the rigid surface areas of the cartridge where the first seals are to be formed. Thus, for example, forming the seals can be a two-step process: first, forming the second seals between the membrane and the cartridge using the hot-plate patterned for the second seals, and then, forming the first seals using the hot-plate patterned for the first seals. One skilled in the art could use other heat-sealing processes to make the first seals and second seals having different seal strength as disclosed herein.

In a laser sealing process, the strength of a seal depends on the following three process variables: the wavelength of a laser beam (in turn, interfacial temperature), exposure time of the beam, and pressure. The laser can be fiber laser, carbon-dioxide laser, etc. Pressure is controlled via a clamping mechanism, by creating a vacuum between the membrane and the surface areas of the cartridge such that there is a pressure differential between the pressure inside the vacuum and atmospheric pressure, or by applying a positive pressure, either directly or with a bladder. Laser beams from a laser source penetrates the membrane from the side with the exterior layer and delivers power to the interface between the membrane and rigid surfaces of the cartridge, and at the interface, the laser power converts to heat energy melting the sealant layer, which is at the interface, to form the seals. For this reason, in specific embodiments each layer of the membrane is transmissive for the laser beams. The strength of the two seals depends on the wavelength of the laser beam: different wavelengths generate different temperatures at the interface and therefore, form seals of different strengths. A scanner system of the laser sealing machine guides the laser beam in accordance with the layout of the rigid surface areas, thus allowing the machine to apply beams having a first wavelength at the rigid surface areas where the first seals are desired and beams having a second wavelength at the rigid surface areas where the second seals are desired. In this way, the first seals are formed at a first set of wavelength, exposure time, and pressure, and the second seals are formed at a second set of wavelength, exposure time, and pressure.

In specific embodiments of the cartridge, the first seals are peelable seals in that although the first seals remain intact at a target pressure that breaks the second seals and further remain intact an operational pressure of the fluid dispensing device, the first seals are not so strong that they cannot be peeled away, for example, by hand or an instrument, in a nondestructive manner. During formation of the first seals at the factory, the set of process variables described above are chosen such that the first seals are peelable. Peelable first seals facilitate easy replacement of the membrane with a new membrane after the cartridge has been used by a user and thereby, facilitate refurbishing the cartridge at a factory, for example.

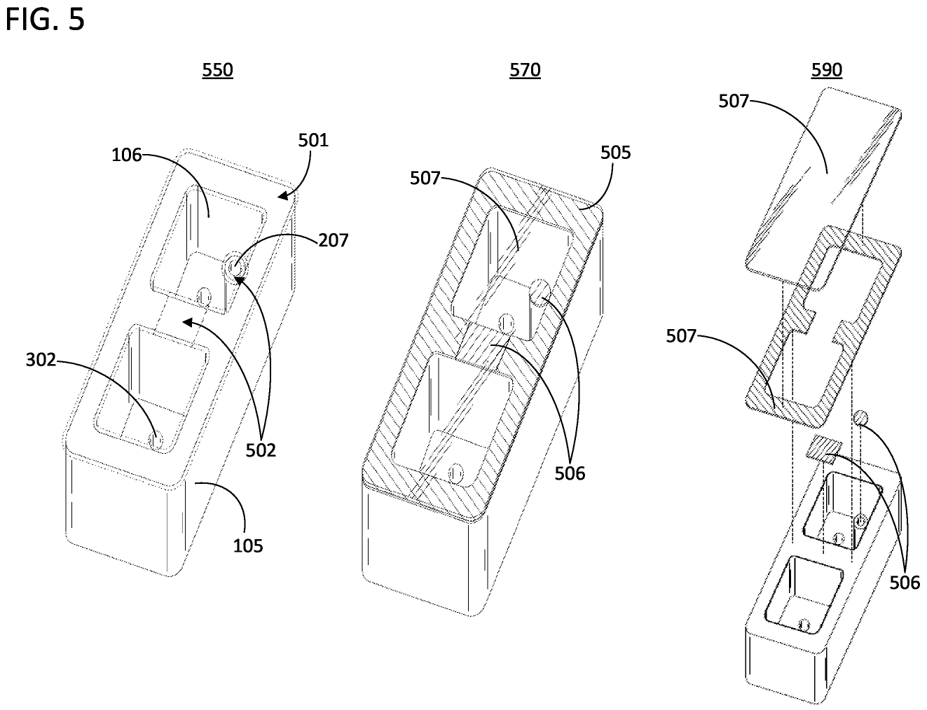

In various embodiments of the cartridge, in accordance with the invention, at least one membrane is attached to the cartridge by one or more first seals and one or more second seals. An example of attaching, by one or more first seals and one or more second seals, a membrane to the top side of a cartridge having two ingredient reservoirs can be given in reference to FIG. 5 in accordance with specific embodiments of the invention. View 550 in FIG. 5 illustrates examples of surface areas for forming the seals on a top side of a cartridge with two ingredient reservoirs, in accordance with specific embodiments of the invention disclosed herein. View 550 illustrates the cartridge 105, two ingredient reservoirs 106, two orifices 302 at the bottom of the ingredient reservoirs, and a gas inlet 207. Further, in view 550, reference 501 illustrates a first rigid surface area 501 (enclosed inside dotted lines) on a top surface of a plurality of walls of the ingredient reservoirs and cartridge. A first seal is desired to be formed at the first rigid surface area. Reference 502, in view 550, illustrates two second rigid surface areas (enclosed inside dashed lines): one on a top surface of an internal wall that is shared by the two ingredient reservoirs and the other, a circle-shaped surface area, that surrounds the gas inlet and is on the same horizontal plane as the first rigid surface area 501 on the cartridge's peripheral walls. Two second seals are desired to be formed at the two second rigid surface areas: one second seal for one at each of the two second rigid surface areas. View 570 illustrates a membrane 507 that is disposed above, and covers, the two ingredient reservoirs at the top side of the cartridge. The illustrated membrane is a transparent membrane; however, this is not a limitation of the invention. View 570 further illustrates that the membrane is attached, by one first seal 505, to the first rigid surface area 501 of the cartridge and by two second seals 506 to the second rigid surface areas 502 of the cartridge. In this illustration, the membrane attached by a second seal over the gas inlet to prevent, during the shipment of the cartridge and before the cartridge is installed in a fluid dispensing device at a user's premise, leakage, through the gas inlet, of the liquid ingredient contained in the ingredient reservoir that houses the gas inlet and its pipe/tube. View 590 illustrates an exploded view of the membrane and seals of view 570.

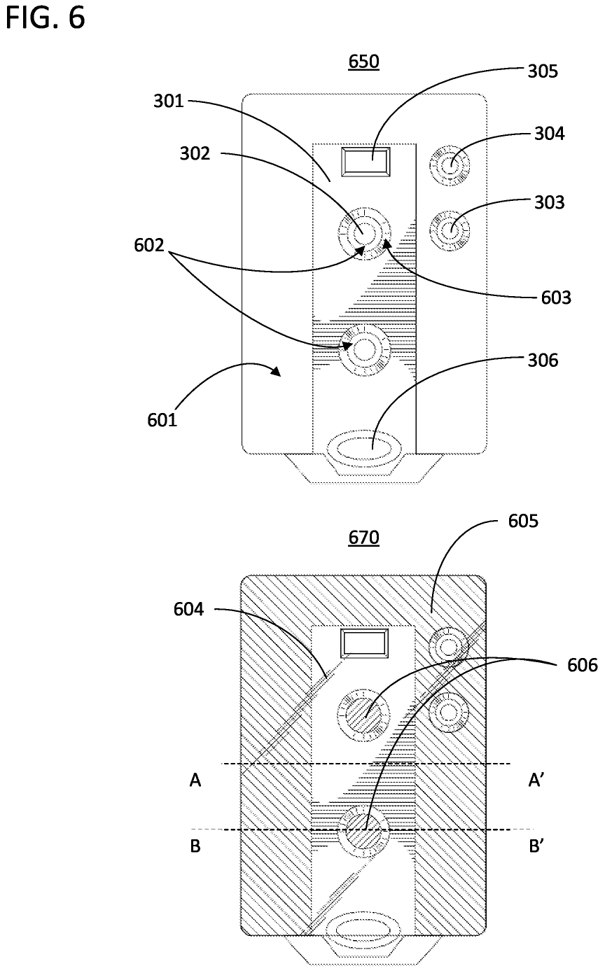

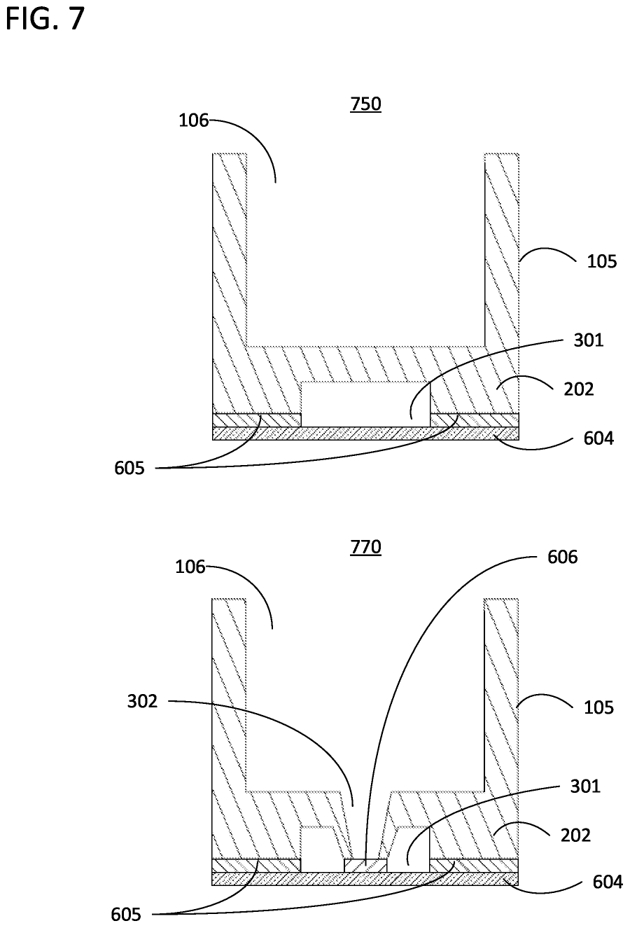

An example of attaching, by one or more first seals and one or more second seals, a membrane to the bottom side of the cartridge in FIG. 5 can be given in references to FIGS. 6 and 7. In FIG. 6, view 650 illustrates examples of surface areas for forming the seals on a bottom side of the base of a cartridge with two ingredient reservoirs in accordance with specific embodiments of the invention disclosed herein. View 650 illustrates some of the features of the cartridge at the bottom side of the cartridge's base that have already been discussed above in connection with FIG. 3. In view 650 of FIG. 6, reference 301 illustrates a channel, 302 illustrates two orifices that are disposed within the channel, 303 illustrates gas inlet (the bottom side of gas inlet 207 in FIG. 5), 304 illustrates fluid inlet, 305 illustrates a connection point enabling solvents or pressurized gas from the fluid inlet 304 to enter the channel 301, and 306 illustrates a fluid outlet. Reference 601 illustrates a first rigid surface area, in the shape of an inverted-U, at the bottom of the base of the cartridge where a first seal is desired to be formed, and reference 602 illustrates two second rigid surface areas at the bottom of the base where two second seals are desired to be formed. Similar to the surface areas in view 350 of FIG. 3, a second rigid surface area 602 completely surrounds an orifice and forms a mesa, and a surface area 603 is on a protruding part of the bottom side of the cartridge located within the channel 301. In the cartridge embodiment illustrated in FIG. 6, there are two orifices, and therefore, two second rigid surface areas illustrated in view 650. Each of the two second rigid surface areas completely surrounds a respective one of the two orifices. The first rigid surface area partially surrounds the channel 301 on the channel's three sides. View 670 illustrates a membrane 604 that is disposed below, and covers, the channel and the two orifices at the bottom side of the cartridge. The membrane 604 is attached, by one first seal 605, to the first rigid surface area 601 of the cartridge and by two second seals 606 to two second rigid surface areas 602 of the cartridge. As seen in view 650, the first rigid surface area 601 is of an inverted-U shape, and so, in view 670, the first seal 601 is correspondingly of an inverted-U shape; however, this is not a limitation of the invention. In this embodiment, there are a first seal and two second seals at the bottom side of the cartridge. FIG. 7 illustrates example cross-sectional views of the base of the cartridge in FIGS. 5 and 6. View 750 illustrates an example cross-sectional views of the base of the cartridge along line A-A′ in view 670 in FIG. 6. View 750 illustrates cartridge 105, ingredient reservoir 106, base 202 of the cartridge, channel 301, membrane 604, and first seal 605. View 770 illustrates an example of a cross-sectional view of the base of the cartridge along line B-B′ in view 670 in FIG. 6. View 770 illustrates the features described in view 670 and further illustrates orifice 302 and second seal 606 by which membrane 604 is attached to the second rigid surface area 602 surrounding the orifice.

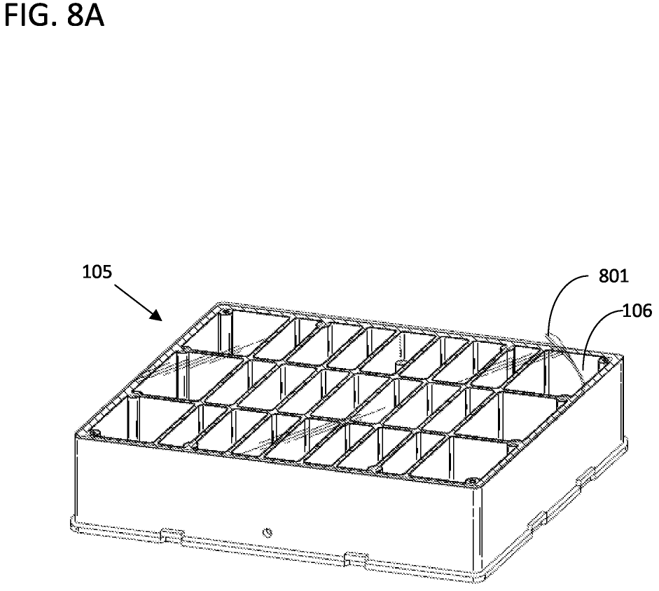

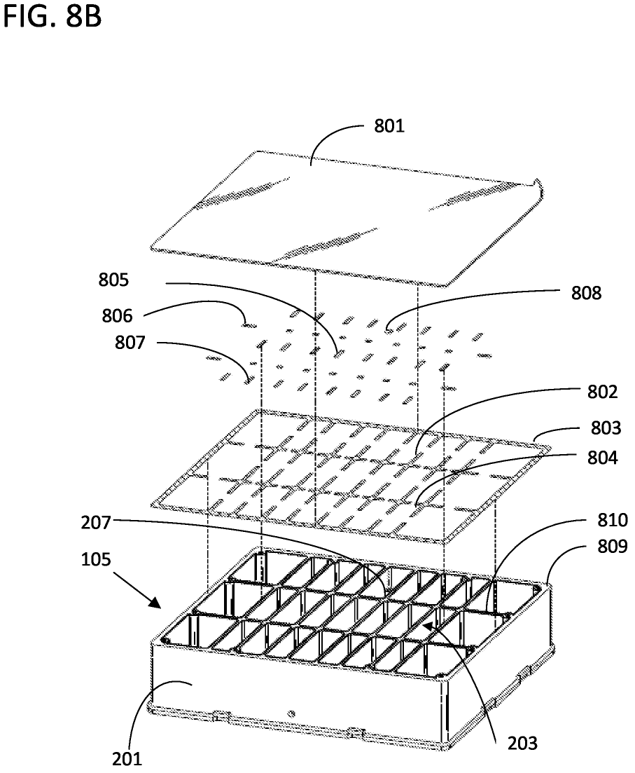

FIG. 8A illustrates a membrane attached, by a plurality of first seals and a plurality of second seals, to the top side of a cartridge in FIG. 2, in accordance with specific embodiments of the invention. In FIG. 8A, a membrane 801 is attached to the top side of the cartridge. The membrane is disposed above, and covers, a plurality of ingredient reservoirs 106 at the top side of the cartridge. As discussed, the cartridge 105 of this embodiment has twenty-seven ingredient reservoirs. The membrane 801 is attached to the cartridge by a plurality of first seals and a plurality of second seals. FIG. 8B illustrates an exploded view of the membrane and seals: the plurality of first seals, as illustrated by references 802, 803, 804, and the plurality of second seals, as illustrated by 805, 806, 807. In FIG. 8B, second seal 808 is over gas inlet 208 as discussed above in connection FIG. 5. The plurality of first rigid surface areas at which the plurality of first seals are formed are illustrated by reference 809, and the plurality of second rigid surface areas at which the plurality of second seals are formed are illustrated by reference 810—similar to the surface areas illustrated in view 550 in FIG. 5. Thus, in FIG. 8A, the membrane is attached, by the plurality of first seals, to a plurality of first rigid surfaces of the cartridge, and the membrane is attached, by the plurality of second seals, to a plurality of second rigid surfaces of the cartridge.

In FIG. 8B, there is a total of seventeen first seals: one first seal, as illustrated by reference 803, that is along top of the peripheral walls 201 of the cartridge and has branches on top of the internal walls 203 of the cartridge plus sixteen first seals, as illustrated by references 802 and 804, on top of the internal walls of the cartridge; each of the sixteen first seals is formed at and about an intersection of two internal walls. Further, in FIG. 8B, there is a total of forty-two second seals, illustrated by references 805, 806, and 807, all of which are on top of the internal walls of the cartridge. In an alternative seal placement layout for the top side of the cartridge in FIG. 8B, one first seal could be formed along top of the peripheral walls of the cartridge without any branches on the internal walls, and one second seal could be formed along the top of all the internal walls (including on the surface areas where the branches of the first seal 803 are shown in FIG. 8B). In yet another variation of the seal placement layout for the top side of the cartridge in FIG. 8B, the branches of the first seal 803 on the internal walls and all the first seals on the internal walls (as mentioned, there are sixteen such first seals as illustrated by references 802 and 804) as shown in FIG. 8B could instead be second seals, and one first seal could be formed along the peripheral walls of the cartridge without any branches on the internal walls; in such an embodiment, there would be forty-three first seals and thirty-six second seals on the internal walls of the cartridge. However, the seal placement layout as illustrated in FIGS. 8A and 8B is beneficial in that each of the first seals on the internal walls is located at and about an intersection between two internal walls; as such, they provide better structural support for the membrane during the operation of the fluid dispensing device because the membrane is attached to the cartridge in a distributed manner.

As illustrated in FIG. 8B, each ingredient reservoir is sealed on its top side by the membrane, multiple first seals, and at least one second seal such that the top side of each ingredient reservoir is completely sealed and closed. As such, each ingredient cartridge is hermetically sealed on its top side before the cartridge is installed into a fluid dispensing device. “Hermetically sealed” means that the liquid ingredient contained in an ingredient reservoir cannot spill over or leak through the seals (because as discussed above, the membrane's sealant and barrier layers provide barrier against transmission of such molecules as oxygen, vapor, etc.). In this way, during shipment of the cartridge and prior to the installation of the cartridge into a fluid dispensing device, the liquid ingredients contained in ingredient reservoirs are kept separated and isolated, preventing spill-over and cross-contamination among them.

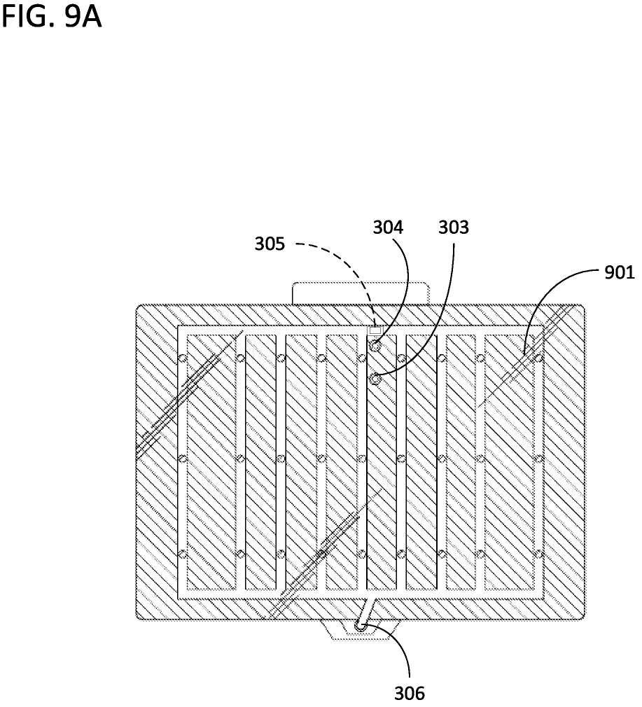

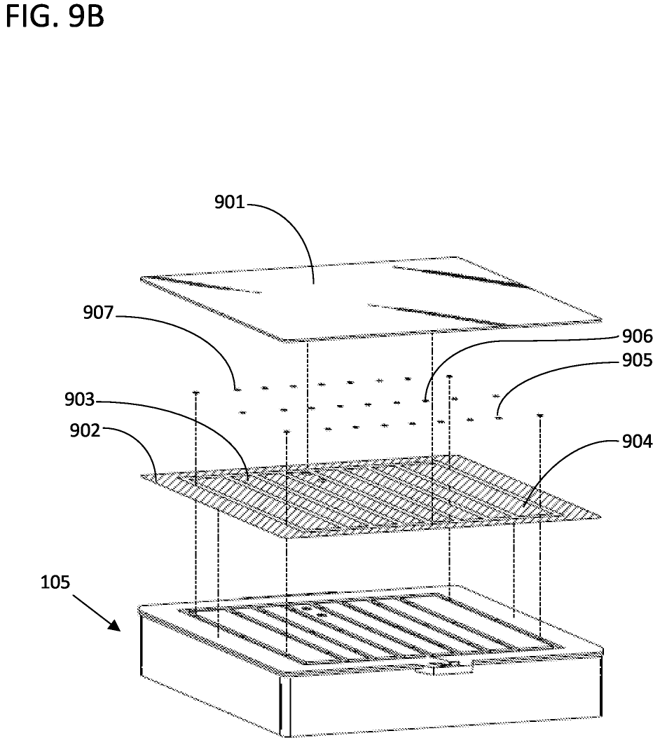

In FIG. 9A, a membrane 901 is attached to the bottom side of the base of the cartridge in FIG. 8A, in accordance with specific embodiments of the invention. The membrane is disposed below, and covers, a plurality of channels and the plurality of ingredient reservoirs' respective orifices at the bottom side of the cartridge. As discussed, the cartridge 105 of this embodiment has twenty-seven orifices at the base of the cartridge-one for each ingredient reservoir. The membrane 901 is attached to the cartridge by a plurality of first seals and a plurality of second seals. FIG. 9B illustrates an exploded view of the membrane and seals in FIG. 9A. In FIG. 9B, there are ten first seals: one on the periphery of the base of the cartridge, as illustrated by reference 902, and nine first seals in parallel to the vertical channels, as illustrated by references 903 and 904. Further, in FIG. 9B, there are twenty-seven second seals, as illustrated by references 905, 906, and 907. As explained above in connection with FIGS. 3 and 6, each orifice is completely surrounded by a second rigid surface area as illustrated in magnified view 350 in FIG. 3: In view 350, reference 302 illustrates an orifice, and reference 307 illustrates a second rigid surface area that surrounds the orifice and forms a mesa, and reference 310 illustrates a surface area on a protruding part of the bottom side of the cartridge located within a channel (in FIG. 3, there are twenty-seven mesas, each surrounding one orifice). A second seal attaches the membrane to a second rigid surface area that completely surrounds an orifice, thereby completely sealing the orifice before the cartridge is installed in a fluid dispensing device. In this way, during the shipment of the cartridge and prior to the installation of the cartridge into a fluid dispensing device, the membrane and the second seal hermetically seals the orifice and prevents leakage of liquid ingredients through the orifices.

The cartridges in accordance with various embodiments of the invention can be serviced at a factory: they can be filled or refilled with liquid ingredients before their shipment to the users of compatible fluid dispensing devices. In specific embodiments in which a membrane is disposed at the top of the cartridge with multiple ingredient reservoirs and a membrane is disposed at the bottom of the cartridge, such as illustrated in FIGS. 5, 6, 7, 8A, 8B, 9A, and 9B, the process for filling/refilling and sealing could proceed as follows. First, the membrane at the bottom is attached to the cartridge by first seals and second seals as described above. Next, the ingredient reservoirs are filled with liquid ingredients, and thereafter, the membrane at the top of the cartridge is attached to cartridge by first seals and second seals as described above. The process could be done in a reverse order: first, the membrane at the top of the cartridge is attached to cartridge by first seals and second seals as described above; then, the ingredient reservoirs are filled with liquid ingredients through the orifices; and finally, the membrane at the bottom is attached to the cartridge by first seals and second seals as described above.

Once the cartridge is filled and sealed as discussed above, the cartridge is shipped to a user of a compatible dispensing device (“compatible” is in the sense that the cartridge is shaped for installation into that particular fluid dispensing device as discussed above). During the shipment of the cartridge, the top membrane, the first seals, and the second seals at the top side of the cartridge prevent spill-over and cross-contamination of the liquid ingredients at the top side, as discussed above, and the bottom membrane and the second seals prevent leakage through the orifices at the bottom side. However, the operation of the fluid dispensing device of specific embodiments requires dispensing liquid ingredients through the orifices. Further, the device operation requires, in specific embodiments, pressurizing a pressurizable chamber above the ingredient reservoirs at the top side of the cartridge that seamlessly spans over all the ingredient reservoirs such that a controllable operational pressure is applied to the fluid surfaces of the liquid ingredients contained in the reservoirs in that all reservoirs are commonly pressurized; this pressurization is done to facilitate dispensing of the ingredients in desired amounts through the orifices. Therefore, the second seals must be broken before the fluid dispensing device can be operational.

The second seals are broken as part of the installation of the cartridge into the fluid dispensing device at the user's premises. As discussed above, during the cartridge's installation, first, the cartridge is inserted or placed into the fluid dispensing device so that various interfacing components of the cartridge (such as channels 301, orifices 302, gas inlet 303, fluid inlet 304, fluid outlet 306, etc.) are mated with their corresponding interfacing components of the fluid dispensing device. Thereafter, a target pressure to break the second seals is applied to the cartridge through the cartridge's gas inlet 303 and/or fluid inlet 304. Additionally, as described elsewhere, the cartridge can have multiple sets of weaker “second” seals that break at different pressures as the pressure of the cartridge is being increased. The cartridge can be configured such that the same pressure is applied to both such sets of weaker seals, or so that two different pressures are applied to the different sets.

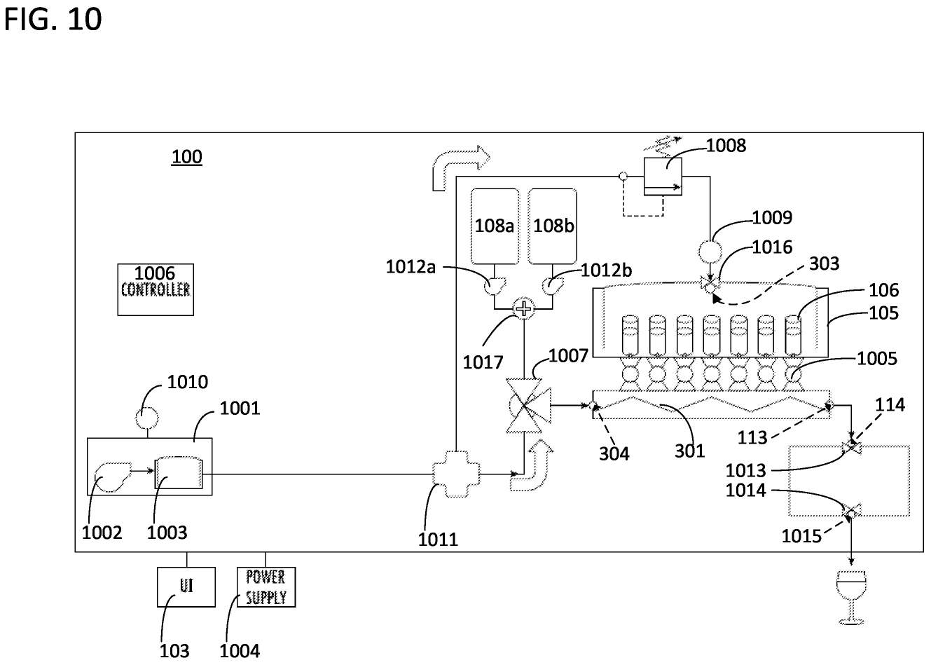

FIG. 10 illustrates a schematic block diagram of exemplary components of a fluid dispensing device such as device 100, including a pneumatic system 1001. The pneumatic system can be any of the pneumatic subsystems described in U.S. patent application Ser. No. 17/548,258 filed on Dec. 2, 2021, U.S. patent application Ser. No. 17/547,612 filed on Dec. 10, 2021, U.S. patent application Ser. No. 17/549,155 filed on Dec. 13, 2021, and Ser. No. 17/549,364 filed on Dec. 13, 2021, all of which are incorporated by reference herein in their entirety for all purposes. During operation of the fluid dispensing device, the pneumatic system can be used to pressurize the pressurizable chamber at the top side of the cartridge 105 and/or to flow pressurized gas/air through the channels 301 at the bottom side of the cartridge to move liquid ingredients and solvents through the channels 301. During installation of the cartridge into the fluid dispensing device, the pneumatic system can be used to supply pressure to the cartridge to break the second seals. This pneumatic system 1001 can include a pressure source, such as an air pump 1002, and a pressure accumulator 1003, which operates as a pressure storage for the system. The pressure source can be energized by power supply 1004 and pressurize the accumulator 1003 at desired pressure level. In specific embodiments, pneumatic system 1001 can supply pressurized gas or air from an external source and store it in an accumulator or directly supply to other parts of the dispensing device.

FIG. 10 illustrates other components of the dispensing device after a cartridge of specifics embodiment of the invention has been inserted or placed into the device. These components, some of which have already been mentioned above, are: cartridge 105, the cartridge's ingredient reservoirs 106, the cartridge's channels 301, the cartridge's gas inlet 303, the cartridge's fluid inlet 304, the cartridge's fluid outlet 113, mixing chamber's inlet 114, solvent reservoirs 108a, 108b, pumps 1012a, 1012b for the solvent reservoirs, dispensing valves 1005 of the dispensing device (these valves act on the membrane at the bottom of the cartridge to open and close the orifices during the operation of the dispensing device), and a controller 1006. FIG. 10 illustrates additional illustrative components that are used to supply and/or regulate pressure to the cartridge: flow control valve 1016 (to control flow of pressurized gas/air to the cartridge's gas inlet), a three-way valve 1007 (to flow solvents from the solvent reservoirs to the channels, or, to flow pressurized gas/air from the pneumatic system to the cartridge's channels via the cartridge's fluid inlet), a pressure regulator 1008 (to keep pressure above the ingredient reservoirs at a desired pressure level adequate for dispensing liquid fluid), pressure sensors 1009, 1010, connectors 1011, 1017 (connectors are essentially splitters and combiners which can split or combine flows of air or fluid between multiple paths), the mixing chamber's inlet valve 1013 (to control flow between the cartridge's outlet 113 and the mixing chamber's inlet 114), and the mixing chamber's outlet valve 1014 (to control flow between the mixing chamber and through its fluid outlet 1015 to the dispensing area outside the device).

The controller 1006 is configured to execute instructions to control, actuate, and operate various pumps, valves, sensors, and regulators of the fluid dispensing device. The controller can be any of the controllers described in U.S. patent application Ser. No. 17/548,258 filed on Dec. 2, 2021, U.S. patent application Ser. No. 17/547,612 filed on Dec. 10, 2021, U.S. patent application Ser. No. 17/549,155 filed on Dec. 13, 2021, and Ser. No. 17/549,364 filed on Dec. 13, 2021, all of which are incorporated by reference herein in their entirety for all purposes.

As mentioned, during the installation of the cartridge into the dispensing device, pressurized air is used to break the second seals. Once the cartridge 105 is inserted into the fluid dispensing device 100 (the insertion comprises a step of the installation process), a user of the device can turn on the power supply 1004 to the system. The user can then instruct the device to complete the installation process by breaking the second seals. The user can so instruct by using the user interface (UI) 103. In specific embodiments, the steps of this portion of the installation process can be carried out by the controller 1006, in response to the user's instruction, by executing a set of executable instructions stored in a memory of the controller or the fluid dispensing device.

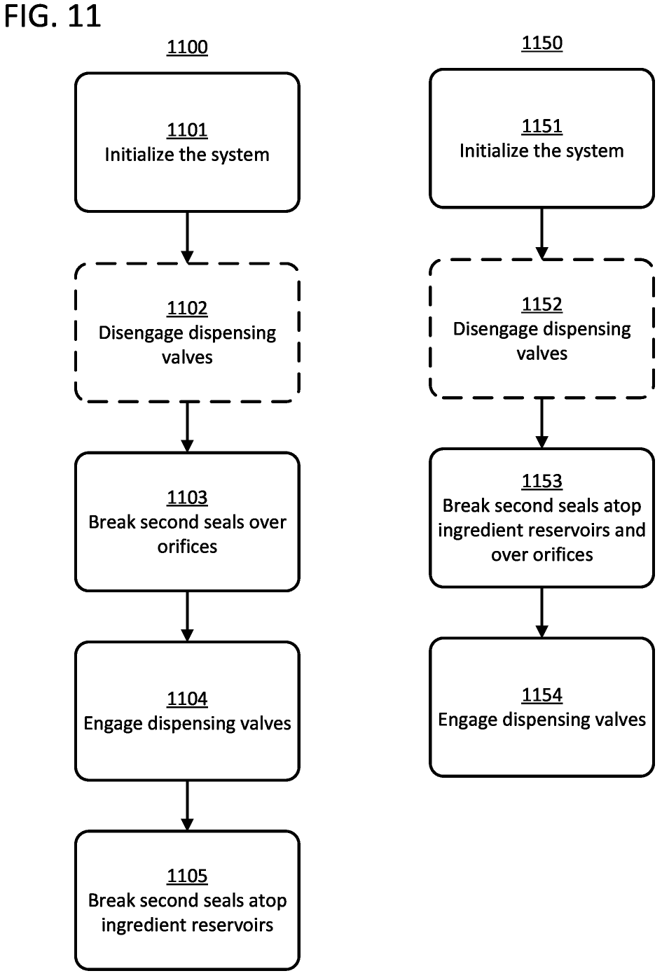

FIG. 11 illustrates a flowchart 1100 for a method for breaking the second seal or seals, after a cartridge has been inserted into the fluid dispensing device, in accordance with specific embodiments of the invention. Each step of the method is conducted by the controller 1006 executing stored instructions. In the following, the method steps are described in reference to specific embodiments of the cartridge as illustrated in FIGS. 8A, 8B, 9A, and 9B.

The method of flowchart 1100 starts at step 1101 of initializing the system of the device 100. At this step, the controller can open or close various valves of the system and turn on or off various components of the system. For example, the controller can turn off pumps 1012a and 1012b of the solvent reservoirs (so no solvent can flow into the cartridge's channel), open three-way valve 1007 on the path between the solvent reservoir pumps and the cartridge's fluid inlet 304 (so that pressure can build up to a sufficient level between connector 1011 and the three-way valve 1007 and on path between connector 1011 and pressure regulator 1008) and close flow control valve 1016 (so that pressure can build up to a sufficient level between pressure regulator 1008 and cartridge's gas inlet 303). Moreover, during this step, the controller can open the mixing chambers inlet and outlet valves 1013 and 1014 such that there is an open path for pressurized air to flow from the cartridge's fluid inlet 304 to an outside of the device through the dispensing area; this is done so that in the following steps of the method, when pressurized air is forced through the cartridge's fluid inlet 304 and through the channels 301, the pressure is exerted on the membrane and second seals more effectively.

Further, during step 1101, the controller may poll sensor 1010 to determine whether the accumulator has sufficient pressure. In specific embodiments, a sufficient pressure for the accumulator can be an operational pressure of the system, such as the operational pressure needed in the cartridge's pressurizable chamber to dispense ingredients or the operational pressure needed to move ingredients and solvents through the channel-subsequent to the installation of the cartridge into the fluid dispensing device and during the operation of the device. In other embodiments, a sufficient pressure for the accumulator can be the target pressure needed to break the second seals, which can be less than the operational pressure of the system. The operational pressure and target pressure can be stored in a memory of the controller or system, and the controller can read it during step 1101. If the pressure of the accumulator is not at a sufficient level, the controller can actuate pump 1002 to pressurize the accumulator at the sufficient level.

Flowchart 1100 continues to step 1102 of disengaging the dispensing valves of the fluid dispensing device. This step is optional in that if after inserting the cartridge into the device, the dispensing valves were disengaged, this step can be skipped. During this step, the controller disengages the dispensing valves 1005 so that the dispensing valves do not press the membrane disposed at the bottom of the cartridge against the cartridge's orifices. This is done so that during the next step of the method, pressurized air flow has an unobstructed flow-path to the second seals.

Flowchart 1100 continues to step 1103 of breaking the second seals over the orifices. During this step, the controller 1006 switches the three-way valve 1007 to open the path between the connector 1011 and the cartridge's fluid inlet 304. Pressurized air now flows from the pneumatic system through the cartridge's fluid inlet 304, the cartridge's channels 301, and mixing chamber 107 to a dispensing area outside the device. The pressurized air's pressure is at or above the target pressure at which the second seals break. Therefore, the second seals over the orifices break; however, the first seals remain intact: this is because the first seals are strong enough not to break at the target or operational pressures. At the conclusion of step 1103, the membrane disposed at the bottom of the cartridge remains attached to the bottom surface of the cartridge's base by the first seals. In this way, for example, one or more fluid paths are created by the membrane, the first seals, and the channels-through which, during the operation of the fluid dispensing device, liquid ingredients (dispensed through the orifices) and solvents (supplied from the solvent reservoirs) can flow to other components of the dispensing device, such as a mixing chamber or a nozzle, to form a fluid mixture or beverage.

Flowchart continues to step 1104 of engaging the dispensing valves. The controller 1006 can actuate the dispensing valves so that they press the membrane against the orifices and thereby, close the orifices. This is done because by now the second seals over the orifice have been broken and therefore, liquid ingredients contained in the ingredients reservoirs of the cartridge can leak through the otherwise open orifices.

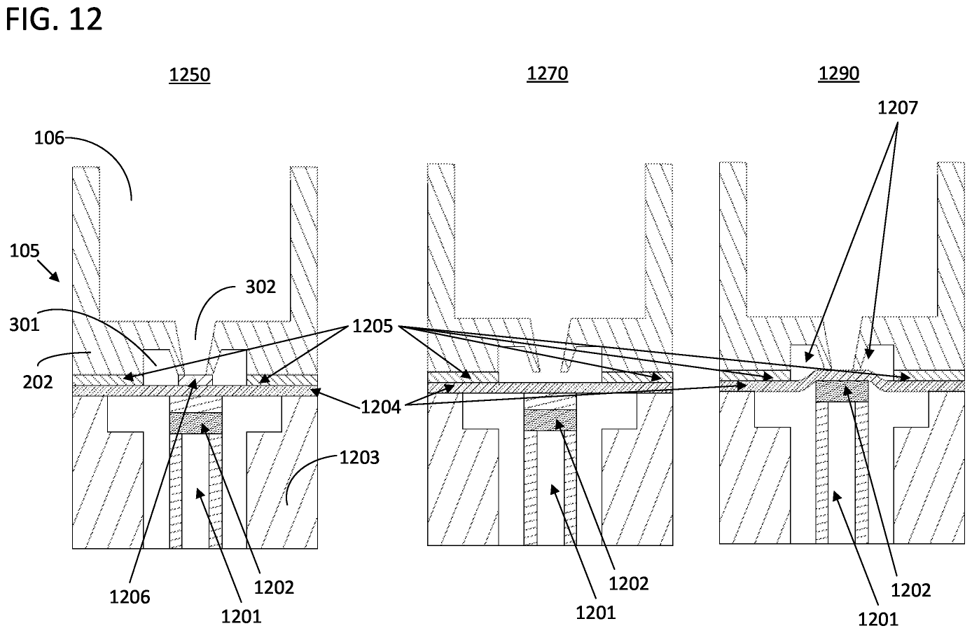

FIG. 12 illustrates example cross-sectional views of a dispensing valve, an orifice, a membrane, and seals during the installation of a cartridge into the device, in accordance with specific embodiments disclosed herein. In the figure, a portion of cartridge 105 is illustrated with one exemplary ingredient reservoir. View 1250 illustrates the state of the seals and membrane at the end of step 1102: it illustrates channel 301, ingredient reservoir 106, its orifice 302, the cartridge's base 202, dispensing valve 1201, a rubber pad 1202 (e.g., a fluoroelastomer pad) on top of the dispensing valve, and the dispensing device's base plate 1203 in which the dispensing valve is housed. As illustrated in view 1250, after the cartridge is inserted into the fluid dispensing device and at the conclusion of step 1102, the valve and rubber pad are disengaged (i.e., the rubber pad does not press the membrane against the orifice) and the membrane remains attached to the cartridge by first seals 1205 and second seals 1206; the second seals are over orifice 302. View 1270 illustrates the state of the membrane and seals at the conclusion of step 1103: in particular, the second seal has been broken and the orifice is now open. At this point in the installation process, the dispensing valve is still disengaged from the membrane and orifice. View 1290 illustrates the state of the membrane and seals at the end of step 1104: The dispensing valve has been engaged by pressing the membrane 1204 against the orifice 302 and thereby closing the orifice. In view 1290, a fluidic path 1207 is formed around the orifice, and the fluidic path is bounded by the membrane on its side facing the orifice and the surface of the channel. The fluidic path is fluidly connected to other parts of the dispensing device such as mixing chamber 107 in FIG. 1B. After the installation of the cartridge into the fluid dispensing device and during the operation of the dispensing device, according to specific embodiments of the invention, when the orifice is selectively opened (by disengaging the dispensing valve and rubber pad from the membrane), a liquid ingredient is dispensed from the ingredient reservoir into the channel and one or more solvents are flowed into the channel from one or more solvent reservoirs, such as solvent reservoirs 108a, 108b in FIG. 1B. The so dispensed ingredient and flowed solvents flow through the fluidic path just described to the cartridge's fluid outlet, such as fluid outlet 113 in FIG. 1B, and into a mixing chamber, such as mixing chamber 107, via the mixing chamber's fluid inlet 114.

Flowchart continues to step 1105 of breaking the second seals at the cartridge's surface areas atop the ingredient reservoirs at the top side of the cartridge. This step can be accomplished by forcing pressurized air through the cartridge's gas inlet 303. During this step, the controller sets the pressure regulator 1008 to regulate the pressure of its output flow to the cartridge at the operational pressure that is used, later during the operation of the fluid dispensing device, to pressurize the reservoirs from their top side and facilitate dispensing liquid ingredient through their orifices. Alternatively, the controller can set the regulator's output pressure at the target pressure at which the second seals break. The controller 1006 opens the flow control valve 1016. Pressurized air from the pneumatic system, further regulated by the pressure regulator 1008, breaks a second seal that covers the cartridge's gas inlet at the top side of the cartridge, such as gas inlet 207 in FIG. 2, and enters the ingredient reservoir that houses the top end of the gas inlet and pressurizes that reservoir. As mentioned, each ingredient reservoir is sealed at its top side by one or more first seals and one or more second seals. As pressure increases at or above the target pressure within the reservoir that houses the gas, the second seals atop the walls of that reservoir break, and pressurized air flows into the neighboring reservoirs that share the walls on which the second seals, now broken, existed. Then, pressure increases in the neighboring reservoirs and breaks the second seals on their other walls not shared with the reservoir that houses the gas inlet. This process of breaking the second seals continues until all the second seals atop the walls of the cartridge are broken. However, the first seals atop the walls of the cartridge remain intact, because as mentioned, the first seals are strong enough not to break at the target pressure or the operational pressure.

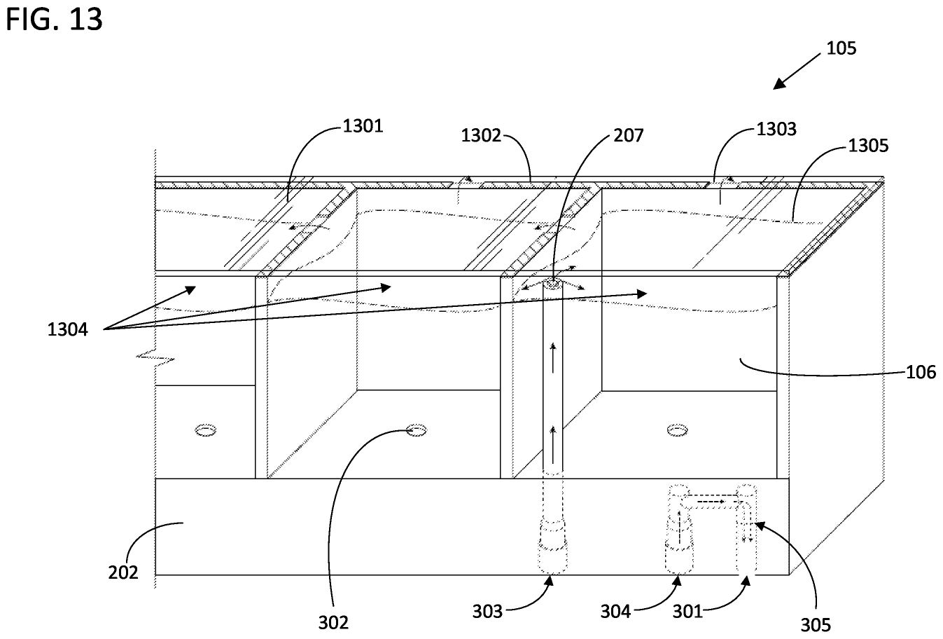

At the conclusion of step 1105, the membrane disposed on the top side of the cartridge remains attached to the top of cartridge by the first seals. In this way, a pressurizable chamber is formed that is closed in all directions: by the membrane above, the cartridge's peripheral walls on the lateral sides on top of which the membrane is attached by a first seal, such as first seal 803 in FIG. 8B, and the surfaces of the liquid ingredients contained in the ingredient reservoir. Further, because pressurized air moves from one reservoir to another through the passages created by breaking the second seals, pressure supplied from the pressure regulator ultimately is distributed throughout the entire chamber resulting in a commonly pressurized chamber in that the same pressure is exerted on the surfaces of liquid ingredients contained in all reservoirs. FIG. 13 illustrates that membrane 1301 is attached to a cartridge at the top of its walls by first seals 1302 but second seals have been broken (indicated by air flow arrows and space 1303 between two first seals) at the conclusion of step 1105. As mentioned, a flow of pressurized air is supplied from the pneumatic system of the fluid dispensing device through gas inlets 303, 207 to the top side of the cartridge 105. At the conclusion of step 1105, a pressurizable chamber 1304 as described above is formed above the liquid surfaces 1305 of the liquid ingredients contained in the ingredient reservoirs 106. Flowchart 1100 ends at step 1105.

As discussed above, during the operation of the device, the pressurizable chamber can be pressurized by supplying pressurized air through an inlet, such as inlet 303, from pneumatic system 1001. A pressure within the chamber, i.e., an operational pressure, facilitates dispensing of the liquid ingredients through the ingredient reservoirs' respective orifices. The pressurizable chamber can be pressurized to the operational pressure also during step 1104 of the installation process because, as discussed above, the regulator 1108 can be set to regulate the pressure of its output flow to the cartridge at the operational pressure. Thus, during step 1105, as the pressure within the chamber gradually increases toward the operational pressure, the second seals at the top of the cartridge walls break when the pressure within the chamber reaches the target pressure, which is, in this example, lower than the operational pressure.

Flowchart 1100 has been described in reference to an exemplary cartridge as illustrated FIGS. 8A, 8B, 9A, and 9B. In some embodiments, a membrane may not be attached, by one or more second seals, at the top side of the cartridge, but a membrane may be attached, by one or more second seals, at the bottom side of the cartridge; in such embodiments, step 1105 can be skipped and certain initialization functions carried out during step 1101 discussed above can be skipped. In yet other embodiments, a membrane may not be attached, by one or more second seals, at the bottom side of the cartridge, but a membrane may be attached, by one or more second seals, at the top side of the cartridge; in such embodiments, steps 1102, 1103, and 1104 can be skipped and initialization functions carried out during step 1101 discussed above can be skipped.

FIG. 11 also illustrates a flowchart 1150 for an alternate method for breaking the second seal or seals, after a cartridge has been inserted into the fluid dispensing device, in accordance with specific embodiments of the invention. In the alternate method, a pressure from pressurized air supplied to the top of the cartridge is used not only to break the second seals attaching a membrane to the top of the cartridge but also to break the second seals attaching a membrane to the orifices at the bottom of the cartridge as illustrated in FIGS. 8A, 8B, 9A, and 9B. Flow chart 1150 begins at step 1151 of initializing the system of the device 100. Step 1151 is similar to step 1101 of flowchart 1100 with the exceptions that certain initialization functions carried out in step 1101 are skipped: for example, the operation of the three-way valve and opening and closing of the cartridge's fluid inlet and outlet valves 304, 113, the mixing chamber's fluid inlet and outlet valves 114, 1015.

Flowchart 1150 continues to step 1152, which is identical to the step 1102 of flowchart 1100. Thereafter, flowchart 1150 continues to step 1153 of breaking the second seals both at the top of the cartridge and at the bottom of the cartridge. Step 1153 is similar to step 1105 of flowchart 1100 in that the functions carried out during step 1105 are also carried out in step 1153 to break the second seals at the cartridge's surface areas atop the ingredient reservoirs at the top side of the cartridge. However, the pressure applied from pressurized air to break these second seals is transferred or transmitted through the liquid ingredients contained in the ingredient reservoirs and exerted onto the second seals over their respective orifices. When the transferred pressure is at or above the target pressure, the second seals over the orifices break. The amount of pressure that is transferred through the liquid ingredients in this manner may be a function of the viscosity and composition of the liquid ingredients; therefore, the pressure applied at the top of the ingredient reservoirs may need to be of such a level that the pressure exerted onto the second seals over the orifices is at or above the target pressure. Thus, the amount of pressure applied at the top of ingredient reservoirs' liquid surfaces may be more than what is needed to break the second seals in step 1105 of flowchart 1100. As mentioned, the controller 1006 can set the pressure regulator 1008 to regulate the pressure of its output flow to the cartridge at a desired level. In this way, during step 1153, the second seals at the top and bottom of the cartridge are broken. Flowchart 1150 then continues to step 1154 of engaging the dispensing valves, which is identical to step 1104 of flowchart 1100. Flowchart 1150 ends at step 1154.

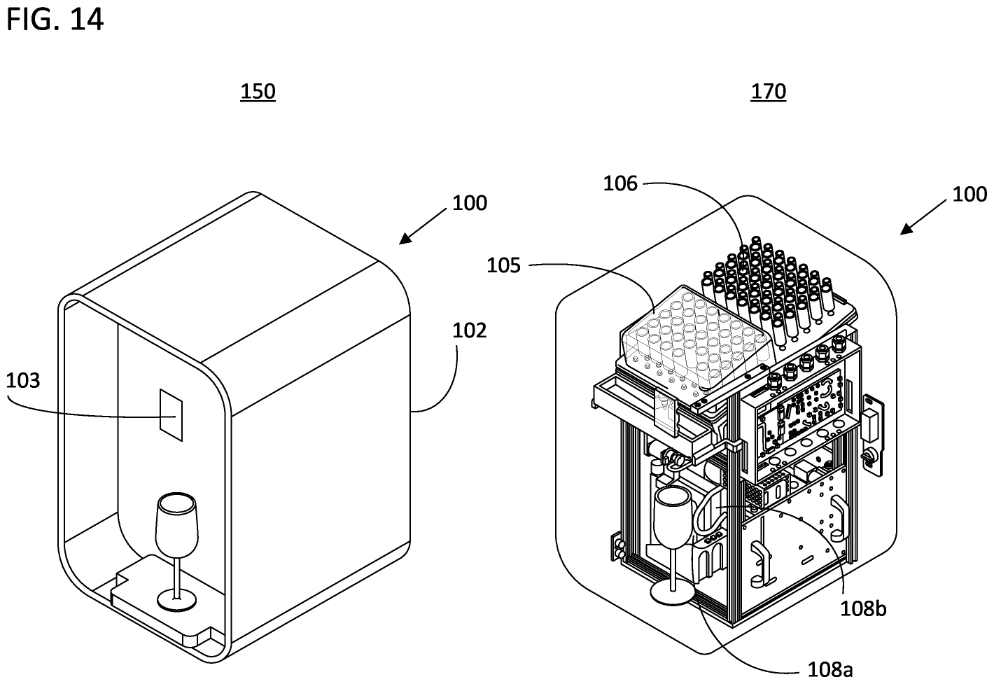

As discussed above, a wide variations of cartridge designs and shapes with one or more attached membranes are possible. In some embodiments, second seals may be present at the bottom of the cartridge, but not at the top of the cartridge. For example, FIG. 14 illustrate a cartridge 105 having ingredient reservoirs 106 that are bladder bags or syringes. Such a cartridge is disclosed in Ser. No. 17/549,670 filed on Dec. 13, 2021, which is incorporated by reference herein in their entirety for all purposes. Because ingredients inside bladder bags and syringes are encapsulated by the bags' or syringes' own leak-proof surfaces at the top side of the cartridge, spill-over and cross-contamination of liquid ingredients during the cartridge's shipment are not manifested; consequently, there is generally no need to attach a membrane by a second seal to the top side of the cartridge, though such a membrane may be attached by one or more first seals to the top side of the cartridge so that a pressurizable chamber can be formed at the top of the cartridge during the operation of the fluid dispensing device. Nonetheless, at the bottom side of such a cartridge, there may be a membrane that covers channels and orifices and is attached to the cartridge by one or more first seals and by one or more second seals as illustrated in FIGS. 9A and 9B. Consequently, embodiments disclosed herein are applicable to such cartridges at the bottom side of the cartridge.

In various embodiments of the cartridge, the number of first seals and second seals between a membrane and the cartridge can vary depending on the number of ingredient reservoirs, the type of dispensing mechanism used in a given fluid dispensing device, etc. For example, a cartridge in accordance with specific embodiments can have only one ingredient reservoir such as ingredient reservoir 106. In such embodiments, a membrane can be attached to the cartridge by one first seal but not by any second seal because the single-reservoir cartridge does not present the problem of spill-over and cross-contamination of liquid ingredients during shipment such as when a cartridge has at least two ingredient reservoirs with different types of liquid ingredients. Nevertheless, in such embodiments, a second membrane can be attached to the cartridge at its bottom side by one second seal over the ingredient reservoir's orifice disposed within a channel, to prevent leakage through the orifice during the shipment of the cartridge, and by one first seal to form a fluidic path between the channel and the membrane during the operation of the fluid dispensing device.

As another example, a cartridge in accordance with specific embodiments of the invention can have only two ingredient reservoirs—i.e., a first ingredient reservoir and a second reservoir—such as ingredient reservoir 106, wherein the first ingredient reservoir has an orifice, such as orifice 302 in FIG. 3, that is located within a channel at the bottom side of the cartridge and is open, and the second ingredient reservoir has an orifice that is located outside the channel but still at the bottom side of the cartridge and is closed by a sealing valve, such as a piercing valve, which can be placed at the factory before shipping the cartridge to a user. In such embodiments, a first membrane can be attached to the top side of the cartridge by one first seal and by two second seals (one of the second seals can cover a gas inlet), as illustrated in FIG. 5, in order to prevent, during the shipment of the cartridge, spill-over and/or cross-contamination of ingredients contained in the two ingredient reservoirs. Further, a second membrane can be attached to the cartridge at its bottom side by one first seal and, to prevent leakage during the shipment of the cartridge, by one second seal over the first ingredient reservoir's orifice as illustrated in FIGS. 6 and 7. However, the second ingredient reservoir's orifice does not require any second seal because its sealing valve prevents leakage during the shipment of the cartridge. As discussed previously, when such a cartridge is installed into a compatible fluid dispensing device, a corresponding pipe of the device can pierce into the sealing valve to establish a fluidic path between the second ingredient reservoir and a pump inside the device, and the pump can draw and dispense, through the sealing valve, a liquid ingredient from the second ingredient reservoir into, for example, a mixing chamber, or another component, of the device. Such an orifice with valve can be used where the liquid ingredient is of high viscosity (for example, a sweetening liquid) such that it may clog a channel, such as channel 301, during the operation of the dispensing device; under such circumstances, a corresponding pump may be useful to dispense the liquid ingredients from such a reservoir. Further, pressurizing a pressurizable chamber from the top side of the ingredient reservoirs, during the installation of the cartridge into the device, is still beneficial to aid the pump to dispense liquid ingredient through such an orifice of the second ingredient reservoir.

In similar fashion, as discussed in the last paragraph, in some embodiments, the bottom side of the cartridge can have a plurality of orifices with sealing valves, such as piercing valves, and a plurality of orifices without any sealing valve, such as orifice 302; in such embodiments, the bottom side of the cartridge may include a membrane that is attached to the cartridge by a plurality of second seals—one over each of the plurality of orifices without any sealing valve, but not any second seal over the plurality of orifices with sealing valves. In yet other embodiments, a cartridge with a plurality of ingredient reservoirs may have a membrane attached to the cartridge by a plurality of first seals and a plurality of second seals at the top side of the cartridge as illustrated in FIGS. 8A and 8B, but may not have any membrane and therefore, may not have any first seal or second seal at the bottom side of the cartridge if the orifices of all of the plurality of ingredient reservoirs have sealing valves, such as piercing valve, discussed above.

A controller, as used in this disclosure for example with reference to controller 1006, can include one or more processors that can be distributed locally within the system or remotely. For example, one or more components of the system, such as valves, pumps, and sensors can be associated to individual microcontrollers that can control their operations and interaction with other components of the system. In specific embodiments of the invention, the controller can be a control system for the overall device even if the various control elements are separately programmed and are not part of a common control hierarchy. The controller can have access to one or more memories that store the instructions for the controllers. The memories can also store information for the system, such as a library of recipes, reference values such as the pressure thresholds and/or target pressure values mentioned in this disclosure, and any other necessary information such as sensor data and the like.

A processor in accordance with this disclosure can include and/or be in communication with at least one non-transitory computer readable media. The media could include cache memories on the processor. The media can also include shared memories that are not associated with a unique processor. The media could be a shared memory, could be a shared random-access memory, and could be, for example, a DRAM. The shared memory can be accessed by multiple channels. One or more non-transitory computer readable media can store data and instructions required for the execution of any of the methods disclosed herein. The computer readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction).

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method disclosed herein can be executed by a processor in combination with a computer readable media storing instructions for the methods in combination with the other hardware elements described above. These and other modifications and variations to the present invention may be practiced by those skilled in the art, without departing from the scope of the present invention, which is more particularly set forth in the appended claims.

What is claimed is:

1. A cartridge shaped for installation into a fluid dispensing device, the cartridge comprising:
at least one ingredient reservoir containing a liquid ingredient, the at least one ingredient reservoir having an orifice; and
a membrane attached to the cartridge by a first seal and a second seal, wherein the first seal is stronger than the second seal;
wherein the second seal is broken as part of the installation of the cartridge into the fluid dispensing device;
wherein the first seal remains intact throughout the installation of the cartridge into the fluid dispensing device and during operation of the fluid dispensing device; and
wherein the liquid ingredient is dispensed from the at least one ingredient reservoir through the orifice during the operation of the fluid dispensing device.

2. The cartridge of claim 1, wherein the cartridge is reusable and refillable.

3. The cartridge of claim 1, wherein:
the cartridge is rigid and made of injection molded materials; and
the membrane is flexible and comprises at least a sealant layer and a barrier layer.

4. The cartridge of claim 3, wherein:
the injection molded materials comprise high-density polyethylene;
the sealant layer is made of linear low-density polyethylene; and
the barrier layer is made of one of metalized polyethylene terephthalate, polyvinylidene dichloride, aluminum foil, aluminum oxide, and silicon oxide.

5. The cartridge of claim 1, wherein the first seal is a peelable seal.

6. The cartridge of claim 1, wherein:
the cartridge comprises an inlet connected to a pressure source external to the cartridge; and
during the installation of the cartridge into the fluid dispensing device, a pressure is supplied, through the inlet, to the cartridge, and the second seal breaks when the pressure is at a target pressure; and
the first seal remains intact at the target pressure.

7. The cartridge of claim 6, wherein:
the target pressure is less than an operational pressure; and
the first seal remains intact at or above the operational pressure.

8. The cartridge of claim 7, wherein:
the operational pressure is between 10 psi and 100 psi; and
the target pressure is between 0.1 psi and 10 psi.

9. The cartridge of claim 1, wherein:
the membrane is attached, by the first seal, to a first rigid surface area of the cartridge; and
the membrane is attached, by the second seal, to a second rigid surface area of the cartridge before the installation of the cartridge into the fluid dispensing device.

10. The cartridge of claim 9, wherein:
the first rigid surface area and the second rigid surface area are on a top surface of a plurality of walls of the cartridge at a top side of the cartridge.

11. The cartridge of claim 9, wherein:
the first rigid surface area and the second rigid surface area are on a bottom surface of a base of the cartridge at a bottom side of the cartridge; and
the second rigid surface area surrounds the orifice of the at least one ingredient reservoir.

12. The cartridge of claim 1, wherein:
the cartridge comprises a plurality of ingredient reservoirs containing liquid ingredients, the plurality of ingredient reservoirs having respective orifices;
the membrane is attached, by a plurality of first seals, to a plurality of first rigid surface areas of the cartridge, wherein the first seal is in the plurality of first seals;
the membrane is attached, by a plurality of second seals, to a plurality of second rigid surface areas of the cartridge before the installation of the cartridge into the fluid dispensing device, wherein the second seal is in the plurality of second seals; and
the liquid ingredients are dispensed from the plurality of ingredient reservoirs through the respective orifices during the operation of the fluid dispensing device.

13. The cartridge of claim 12, wherein:
the plurality of first rigid surface areas and the plurality of second rigid surface areas are on a top surface of a plurality of walls of the cartridge at a top side of the cartridge.

14. The cartridge of claim 12, wherein:
the plurality of first rigid surface areas and the plurality of second rigid surface areas are on a bottom surface of a base of the cartridge at a bottom side of the cartridge; and
each of the plurality of second rigid surface areas surrounds one of the respective orifices.

15. The cartridge of claim 1, wherein:
the cartridge comprises a plurality of ingredient reservoirs containing liquid ingredients, the plurality of ingredient reservoirs having respective orifices;
the plurality of ingredient reservoirs are open at a top side of the cartridge to receive an operational pressure for dispensing the liquid ingredients from the cartridge;
the membrane is disposed above, and covers, the plurality of ingredient reservoirs at the top side of the cartridge;
the membrane and the second seal hermetically seal at least one of the plurality of ingredient reservoirs at the top side of the cartridge before the installation of the cartridge into the fluid dispensing device;
the membrane and the first seal form a pressurizable chamber at the top side of the cartridge after the installation of the cartridge into the fluid dispensing device;
the cartridge comprises an inlet that connects a pressure source external to the cartridge to the pressurizable chamber;
the pressurizable chamber is pressurized, through the inlet, at an operational pressure after the installation of the cartridge into the fluid dispensing device; and
the liquid ingredients are dispensed from the plurality of ingredient reservoirs through the respective orifices during the operation of the fluid dispensing device.

16. The cartridge of claim 15, wherein during the installation of the cartridge into the fluid dispensing device:
pressurized air, from the pressure source, is supplied to the pressurizable chamber through the inlet; and
a pressure from the pressurized air breaks the second seal but not the first seal.

17. The cartridge of claim 15, wherein:
the membrane and a plurality of second seals hermetically seal the plurality of ingredient reservoirs at the top side of the cartridge before the installation of the cartridge into the fluid dispensing device; and
the second seal is in the plurality of second seals.

18. The cartridge of claim 17, wherein during the installation of the cartridge into the fluid dispensing device:
pressurized air, from the pressure source, is supplied to the pressurizable chamber through the inlet;
a pressure from the pressurized air breaks the plurality of second seals.

19. The cartridge of claim 1, wherein:
the cartridge comprises a channel at a bottom side of the cartridge;
the orifice of the at least one ingredient reservoir is disposed within the channel;
the membrane is disposed below, and covers, the channel and the orifice at the bottom side of the cartridge;
the membrane and the second seal hermetically seal the orifice before the installation of the cartridge into the fluid dispensing device; and
the channel, the membrane, and the first seal form a fluidic path from the orifice along the bottom side of the cartridge after the installation of the cartridge into the fluid dispensing device.

20. The cartridge of claim 19, wherein:
the cartridge comprises an inlet that connects a pressure source external to the cartridge to the channel; and
during the installation of the cartridge into the fluid dispensing device:
pressurized air, from the pressure source, is forced into the channel through the inlet; and
a pressure from the pressurized air breaks the second seal.

21. The cartridge of claim 1, wherein:
the cartridge comprises a plurality of ingredient reservoirs containing liquid ingredients, the plurality of ingredient reservoirs having respective orifices, wherein the liquid ingredients are dispensed from the plurality of ingredient reservoirs through the respective orifices during the operation of the fluid dispensing device;
the cartridge comprises a channel at a bottom side of the cartridge;
the respective orifices of the plurality of ingredient reservoirs are disposed within the channel;
the cartridge comprises an inlet that connects a pressure source external to the cartridge to the channel;
the membrane is attached, by a plurality of second seals, to a base of the cartridge at the bottom side of the cartridge, wherein the second seal is in the plurality of second seals;
the membrane covers the channel and the respective orifices;
the membrane and the plurality of second seals hermetically seal the respective orifices before the installation of the cartridge into the fluid dispensing device;
during the installation of the cartridge into the fluid dispensing device:
pressurized air, from the pressure source, is forced into the channel through the inlet; and
a pressure from the pressurized air breaks the plurality of second seals;
the channel, the membrane, and the first seal form a fluidic path from the respective orifices along the bottom side of the cartridge after the installation of the cartridge into the fluid dispensing device.

22. A fluid dispensing device comprising:
a cartridge shaped for installation into a fluid dispensing device and comprising:
at least one ingredient reservoir containing a liquid ingredient, the at least one ingredient reservoir having an orifice;
an inlet;
a membrane attached to the cartridge by a first seal and a second seal, wherein the first seal is stronger than the second seal;
a pneumatic system; and
a controller storing instructions that, when executed, cause the fluid dispensing device to supply, using the pneumatic system, one or more valves, and the inlet, pressurized air to the cartridge;
wherein a pressure from the pressurized air breaks the second seal as part of the installation of the cartridge into the fluid dispensing device;
wherein the first seal remains intact throughout the installation of the cartridge into the fluid dispensing device and during operation of the fluid dispensing device; and
wherein the liquid ingredient is dispensed from the at least one ingredient reservoir through the orifice during the operation of the fluid dispensing device.

23. The fluid dispensing device of claim 22, wherein the pneumatic system comprises a pump and an accumulator.

24. The fluid dispensing device of claim 22, wherein:
the cartridge is rigid and made of injection molded materials; and
the membrane is flexible and comprises at least a sealant layer and a barrier layer.

25. The fluid dispensing device of claim 22, wherein:
the pressure from the pressurized air is a target pressure;
the second seal breaks at the target pressure; and
the first seal remains intact at the target pressure.

26. The fluid dispensing device of claim 25, wherein:
the target pressure is less than an operational pressure; and
the first seal remains intact at or above the operational pressure.

27. The fluid dispensing device of claim 22, wherein:
the membrane is attached, by the first seal, to a first rigid surface area of the cartridge; and
the membrane is attached, by the second seal, to a second rigid surface area of the cartridge before the installation of the cartridge into the fluid dispensing device.

28. The fluid dispensing device of claim 27, wherein:
the first rigid surface area and the second rigid surface area are on a top surface of a plurality of walls of the cartridge at a top side of the cartridge.

29. The fluid dispensing device of claim 27, wherein:
the first rigid surface area and the second rigid surface area are on a bottom surface of a base of the cartridge at a bottom side of the cartridge; and
the second rigid surface area surrounds the orifice.

30. The fluid dispensing device of claim 22, wherein:
the cartridge comprises a plurality of ingredient reservoirs containing liquid ingredients, the plurality of ingredient reservoirs having respective orifices, wherein the liquid ingredients are dispensed from the plurality of ingredient reservoirs through the respective orifices during the operation of the fluid dispensing device;
the plurality of ingredient reservoirs are open at a top side of the cartridge to receive an operational pressure for dispensing the liquid ingredients from the cartridge;
the membrane is disposed above, and covers, the plurality of ingredient reservoirs at the top side of the cartridge;
the membrane and the second seal hermetically seal at least one of the plurality of ingredient reservoirs at the top side of the cartridge before the installation of the cartridge into the fluid dispensing device;
the membrane and the first seal form a pressurizable chamber at the top side of the cartridge after the installation of the cartridge into the fluid dispensing device; and
the pressure is the operational pressure and is provided, using the pneumatic system, one or more valves and the inlet, to the pressurizable chamber.

31. The fluid dispensing device of claim 22, wherein:
the cartridge comprises a plurality of ingredient reservoirs containing liquid ingredients, the plurality of ingredient reservoirs having respective orifices, wherein the liquid ingredients are dispensed from the plurality of ingredient reservoirs through the respective orifices during the operation of the fluid dispensing device;
the cartridge comprises a channel at a bottom side of the cartridge;
the respective orifices of the plurality of ingredient reservoirs are disposed within the channel;
the membrane is attached, by a plurality of second seals, to a base of the cartridge at the bottom side of the cartridge, wherein the second seal is in the plurality of second seals;
the membrane covers the channel and the respective orifices;
the membrane and the plurality of second seals hermetically seal the respective orifices before the installation of the cartridge into the fluid dispensing device;
during the installation of the cartridge into the fluid dispensing device, the pressurized air, from the pneumatic system, is supplied into the channel; and
the channel, the membrane, and the first seal form a fluidic path from the respective orifices along the bottom side of the cartridge after the installation of the cartridge into the fluid dispensing device.

32. A method for installing a cartridge into a fluid dispensing device, wherein the cartridge is shaped for installation into the fluid dispensing device and has a membrane attached to the cartridge by a first seal and a second seal, the method comprising the steps of:
inserting the cartridge into fluid dispensing device; and
supplying, from a pressure source of the fluid dispensing device, pressurized air to the cartridge through an inlet of the cartridge;
wherein the first seal is stronger than the second seal;
wherein the second seal breaks at a pressure from the pressurized air; and
wherein the first seal remains intact at the pressure.

33. The method of claim 32, wherein the pressure is a target pressure.

34. The method of claim 32, wherein the pressure is an operational pressure.

35. The method of claim 32, wherein:
the cartridge is rigid and made of injection molded materials; and
the membrane is flexible and comprises at least a sealant layer and a barrier layer.
